(19) United States
(12) Patent Application Publication
(10) Pub. No.: US 2012/0200549 A1
(43) Pub. Date: Aug. 9, 2012

(54) Display Device And Drive Method For Display Device

(75) Inventors: Yasushi Sasaki, Osaka-shi (JP); Yuhichiroh Murakami, Osaka-shi (JP); Shige Furuta, Osaka-shi (JP); Seijirou Gyouten, Osaka-shi (JP); Shuji Nishi, Osaka-shi (JP)

(73) Assignee: SHARP KABUSHIKI KAISHA, Osaka-shi, Osaka (JP)

(21) Appl. No.: 13/395,518

(22) PCT Filed: Apr. 23, 2010
(86) PCT No.: PCT/JP2010/057283

§ 371 Date: Mar. 12, 2012

(30) Foreign Application Priority Data
Sep. 16, 2009 (JP) 2009-215062

(51) Int. Cl. G09G 3/36; G09G 5/00

(52) U.S. Cl. 345/209; 345/98

(57) ABSTRACT

Provided is a display device which can prevent screen noise caused such that a potential of a common electrode is reversed after a memory mode enters from a refresh period to an entire write-in period, and a method for driving the display device. The memory mode includes (i) an entire write-in period in which a potential of the common electrode (COM) is fixed and the display data is written into all the memory circuits (node (PIX)) in each row and (ii) a refresh period in which the display data which has been written during the entire write-in period is refreshed at least once while the common electrode (COM) is driven. In the memory mode, the potential of the common electrode during the entire write-in period being a potential which the common electrode having been driven had at the end of a refresh period preceding the entire write-in period.

### TECHNICAL FIELD

The present invention relates to a display device having a memory function and a method for driving the display device, and in particular, relates to a technique for reducing screen noise caused because the display device uses a plurality of driving methods for respective display modes.

### BACKGROUND ART

Among liquid crystal display devices, there has been a memory-type liquid crystal display device whose pixels are provided with a built-in memory (hereinafter, referred to as “pixel memory”), so that the display device has a memory function capable of holding image data. Such liquid crystal display device displays a still image by holding image data written in pixels in such a manner that the image data written into the pixels is refreshed by reversing a polarity. In a case of a normal operation (normal mode) in which the memory function is not used, the pixels are overwritten with new image data supplied via data signal lines every frame. Meanwhile, in a case of a memory operation (memory mode) in which the memory function is used, it is unnecessary to supply new image data via the data signal line because the image data is held in the pixels.

Therefore, in the memory operation, an operation of a circuit for driving scanning signal lines and data signal lines can be stopped. This makes it possible to reduce power consumption. Further, the number of times to charge and discharge the data signal lines having a large capacitance can be reduced, and in addition, it is unnecessary to transfer, to a controller, image data for a memory operation period. Those also make it possible to reduce power consumption.

Accordingly, the memory-type liquid crystal display device can be frequently used as a liquid crystal display device for displaying an image strongly required to be displayed with low power consumption, such as a wallpaper image or the like on a cell phone.

FIG. 11 extractively shows merely a circuit configuration of a pixel memory (memory circuit MR100) of a memory-type liquid crystal display device. The memory circuit MR100 is equivalent to that disclosed in Patent Literature 1, for example.

As shown in FIG. 11, the memory circuit MR100 includes a switching circuit SW100, a first data storage section DS101, a data transfer section TS100, a second data storage section DS102, and a refresh output control section RS100.

Further, a substrate (not shown) includes memory circuits MR100 arranged in a matrix manner. As lines for driving memory circuits MR100, a data transfer control line DTx, a gate line GLx, a high power line PHx, a low power line PLx, a refresh output control line RCx, and a storage capacitor line CSx are provided in each row of a pixel matrix of the substrate, and a source line SLx is provided in each column of the pixel matrix of the substrate.

The switching circuit SW100 is constituted by a transistor N100 which is an N-channel TFT (thin film transistor). The first data storage section DS101 is constituted by a capacitor Ca100. The data transfer section TS100 is constituted by a transistor N101 which is an N-channel TFT. The second data storage section DS102 is constituted by a capacitor Cb100. The refresh output control section RS100 is constituted by an inverter INV100 and a transistor N103 which is an N-channel TFT. The inverter INV100 is constituted by a transistor P100 which is a P-channel TFT and a transistor N102 which is an N-channel TFT.

Note that one drain/source terminal of a field effect transistor, such as the aforementioned TFTs, is referred to as “first drain/source terminal”, and the other drain/source terminal is referred to as “second drain/source terminal”. However, whenever it is possible to determine either one of the drain terminal or source terminal based on the direction in which an electric current can flow between the first drain/source terminal and the second drain/source terminal, the terminals are called drain terminal or source terminal, respectively.

A gate terminal of the transistor N100 is connected to the gate line GLx, a first drain/source terminal thereof is connected to the source line SLx, and a second drain/source terminal thereof is connected to a node PIX which is one end of the capacitor Ca100. The other end of the capacitor Ca100 is connected to the storage capacitor line CSx.

A gate terminal of the transistor N101 is connected to the data transfer control line DTx, the first drain/source terminal thereof is connected to the node PIX, and the second drain/source terminal thereof is connected to a node MRY which is one end of the capacitor Cb100. The other end of the capacitor Cb100 is connected to the storage capacitor line CSx.

An input terminal IP of the inverter INV100 is connected to the node MRY. A gate terminal of the transistor P100 is connected to the input terminal IP of the inverter INV100, a source terminal thereof is connected to the high power line PHx, and a drain terminal thereof is connected to an output terminal OP of the inverter INV100. A gate terminal of the transistor N102 is connected to the input terminal IP of the inverter INV100, a drain terminal thereof is connected to an output terminal OP of the inverter INV100, and a source terminal thereof is connected to the low power line PLx.

A gate terminal of the transistor N103 is connected to the refresh output control line RCx, a first drain/source terminal thereof is connected to the output terminal OP of the inverter INV100, and a second drain/source terminal thereof is connected to the node PIX.

Further, the liquid crystal display device includes a counter substrate (not shown), including a common electrode (counter electrode) COM, on a position facing the substrate on which the memory circuit MR100 is formed. The substrate and the counter substrate are provided to sandwich a liquid crystal, and such arrangement constitutes a liquid crystal panel. The liquid crystal capacitor Clc is formed between the node PIX (pixel electrode) of the memory circuit MR100 and the common electrode COM via the liquid crystal.

A memory operation (data holding operation) of the memory circuit MR100 including the aforementioned arrangement will be described below with reference to FIG. 12.

FIG. 12 is a timing chart showing various signal waveforms of the memory circuit MR100 in a memory mode.

In the memory mode, the data transfer control line DTx, the gate line GLx, and the refresh output control line RCx are each applied with a binary-level potential having a high level (active level) or a low level (inactive level). The potential level (high or low) may be set for each line individually.

Further, in the memory mode, a binary-level data signal (also referred to as “binary data”), having a high potential or a low potential, is outputted to the source line SLx from a drive circuit (not shown). A potential supplied from the high power line PHx is equal to the high potential of the binary-level data signal, and a potential supplied from the low power line PLx is equal to the low potential of the binary-level data signal. Further, a potential supplied from the storage capacitor line CSx may be constant, or may be changed at a predetermined timing. However, for the sake of easy explanation, it is assumed that the potential here is set to be constant.

The memory mode has an entire write-in period T101 and a refresh period T102. The entire write-in period T101 is a period in which data to be held in all the memory circuits MR100 is written into the memory circuits MR100 in each row. The entire write-in period T101 includes a period t101 and a period t102 which successively follows the period t101. During the entire write-in period T101, the data is written to the memory circuits MR100 line-sequentially. The period t101 in one row is set so as not to be overlapped with that in any other row. That is, the rows do not start the period t101 simultaneously. Meanwhile, all the rows simultaneously terminate the period t102, i.e., the entire write-in period T101. During the refresh period T102, the data written into the memory circuit MR100 during the entire write-in period T101 is held in refreshing the data. The refresh period T102 includes successive periods t103 to t110. All the rows start the refresh period T102 simultaneously.

During the period t101 of the entire write-in period T101, the potential of the gate line GL is high, while the potentials of the data transfer control line DTx and the refresh output control line RCx are low. This turns on the transistor N100, so that a data potential (here, the potential is high), which has been supplied to the source line SLx, is written into the node PIX.

Next, during the period t102, the potential of the gate line GLx becomes low. This turns off the transistor N100, so that the capacitor Ca 100 holds an electric charge corresponding to the data potential thus written.

Here, in a case where the memory circuit MR 100 is constituted by only the capacitor Ca 100 and the transistor N100, the node PIX is in a floating state as long as the transistor N100 is in an OFF state. In this case, ideally, the capacitor Ca 100 holds the electric charge so that the potential of the node PIX is kept high.

In an actual situation, however, an off-leakage current is generated in the transistor N 100. Accordingly, the electric charge held in the capacitor Ca100 is gradually leaked to the outside of the memory circuit MR100. As the electric charge held in the capacitor Ca100 is leaked, the potential of the node PIX is changed. In a case where the electric charge is leaked for a long time, the potential of the node PIX is changed to such a degree that the data potential thus written loses its meaning that the data potential is supposed to mean.

In view of this, during the refresh period T102 following the entire write-in period T101, the data transfer section TS100, the second data storage section DS102, and the refresh output control section RS100 function to refresh the potential of the node PIX so that the data, which has been written, is not lost.

During the period t103 of the refresh period T102, a potential of the data transfer control line Dtx is high while potentials of the gate line GLx and the refresh output control line RCx are low. This turns on the transistor N101, so that the capacitor Ca100 and the capacitor Cb100 are connected in parallel to each other via the transistor N101. Accordingly, the electric charge is transferred between the capacitor Ca100 and the capacitor Cb100, so that a potential of the node MRY becomes high.

Note that the capacitor Ca100 is set to have a greater capacitance than that of the capacitor Cb100. A positive electric charge is transferred to the capacitor Cb100 from the capacitor Ca100 via the transistor N101, until the potential of the node PIX becomes equal to that of the node MRY. This reduces the potential of the node PIX by a small voltage ΔV1, as compared with the potential of the node PIX during the period t102. However, the potential of the node PIX is still within a range of the high potential.

Next, during the period t104, the potential of the data transfer control line DTx becomes low. This turns off the transistor N101. As a result, the capacitor Ca100 holds an electric charge so that the potential of the node PIX is kept high, and in addition, the capacitor Cb100 holds an electric charge so that the potential of the node MRY is kept high.

During the period t105, a potential of the refresh output control line RCx becomes high. This turns on the transistor N103, so that the output terminal OP of the inverter INV100 is connected to the node PIX. The output terminal OP receives a potential (here, the potential is low) which is reversed from the potential of the node MRY, so that this reversal potential is charged to the node PIX.

During the period t106, the potential of the refresh output control line RCx becomes low. This turns off the transistor N103. Accordingly, the capacitor Ca100 holds an electric charge so that the potential of the node PIX is kept reversed.

During the period t107, the potential of the data transfer control line DTx becomes high. This turns on the transistor N101, so that the capacitor Ca100 and the capacitor Cb100 are connected in parallel to each other via the transistor N101. Accordingly, the electric charge is transferred between the capacitor Ca100 and the capacitor Cb100, so that the potential of the node MRY becomes low. Note that the positive electric charge is transferred to the capacitor Ca100 from the capacitor Cb100 via the transistor N101, until the potential of the node MRY becomes equal to that of the node PIX. This increases the potential of the node PIX by a small voltage ΔV2, as compared with the potential of the node PIX during the period t106. However, the potential of the node PIX is still within a range of the low potential.

During the period t108, the potential of the data transfer control line DTx becomes low. This turns off the transistor N101. As a result, the capacitor Ca100 holds an electric charge so that the potential of the node PIX is kept low, and in addition, the capacitor Cb100 holds an electric charge so that the potential of the node MRY is kept low.

During the period t109, the potential of the refresh output control line RCx becomes high. This turns on the transistor N103, so that the output terminal OP of the inverter INV100 is connected to the node PIX. The output terminal OP is supplied with the potential (here, the potential is high) which is reversed from the potential of the node MRY, and this reversal potential is charged to the node PIX.

During the period t110, the potential of the refresh output control line RCx becomes low. This turns off the transistor N103. Accordingly, the capacitor Ca100 holds an electric charge so that the node PIX keeps holding the reversal potential.

After that, the operations during the periods t103 to t110 are repeated until the refresh period T102 is switched to the next writing period T101 or the next normal mode. During the period t105 of the refresh period T2, the potential of the node PIX is refreshed to be reversed, and is then, during the period t109, refreshed to the potential supplied at the time of the writing. Note that, in a case where data having a low potential is written into the node PIX during the period t101 of the entire write-in period T101, a waveform of the potential of the node PIX is such that a waveform of the potential of FIG. 12 is reversed.

As described above, during a refresh period T2, the memory circuit MR100 can refresh the data, which has been written during an entire write-in period T1, by means of a data reverse method. This makes it possible to prevent an electric charge from reducing due to an off-leakage. Further, a potential of the common electrode COM is reversed between a high potential and a low potential in accordance with a timing in which the data written into the node PIX is refreshed, i.e., a timing in which a polarity of the data is reversed. Accordingly, a screen can be refreshed while a liquid crystal capacitor Clc is AC driven.

The conventional memory-type liquid crystal display device attains to reduce its power consumption with use of the memory mode. Accordingly, the conventional memory-type liquid crystal display device has multiple driving methods corresponding to respective display modes. This causes screen noise (image blur) when a driving method is switched to another driving method.

For example, when the memory mode is switched to the normal mode, the pixel memory holds the data of a still-image display for a while even after the switching. As a result, when the normal mode is switched to the memory mode again, the held data totally different from data to be displayed in the memory mode is displayed for a moment, i.e., screen noise is generated in a moment until new data is written completely into the pixel memory.

In view of the circumstances, for example, Patent Literature 2 discloses a technique for causing all pixel memories to hold all black/all white data at the end of the still-image display period of the memory mode, i.e., a technique for initializing data storage sections of the pixel memories. After the normal mode is switched to the memory mode, the technique prevents previous data from being displayed, that is, prevents screen noise.

### CITATION LIST

### Patent Literatures

Patent Literature 1
Japanese Patent Application Publication, Tokukai, No. 2002-229532 A (Publication Date: Aug. 16, 2002)

Patent Literature 2
Japanese Patent Application Publication, Tokukai, No. 2002-175051 A (Publication Date: Jun. 21, 2002)

### SUMMARY OF INVENTION

### Technical Problem

However, the conventional memory-type liquid crystal display device has a problem of screen noise. The noise is caused by the aforementioned cause, and is also caused such that: in a case where a refresh period is switched to the entire write-in period in a memory mode, a potential of a common electrode COM is reversed between the refresh period and the entire write-in period, and as a result, the screen noise is generated after the refresh period is switched to the entire write-in period.

FIG. 13 shows a conventional liquid crystal display device including a memory circuit MR100, and is a timing chart showing various signal waveforms in a case where screen noise is generated after the memory mode enters from the refresh period to the entire write-in period. In FIG. 13, GLx1, GLx2, and GLx480 indicate potentials of gate lines GL in 1st, 2nd, 480th rows, respectively. CSx1, CSx2, and CSx480 indicate potentials of storage capacitor lines CSx in 1st, 2nd, 480th rows, respectively. PIX1, PIX2, and PIX480 indicate potentials of pixel electrodes of the memory circuit MR100 in 1st, 2nd, 480th rows, respectively. Further, the dotted lines, which are shown to be overlapped with the signal waveforms of PIX1, PIX2, and PIX480 indicate a potential of the common electrode COM.

As shown in FIG. 13, after the refresh period is switched to the entire write-in period, i.e., during the entire write-in period, the gate lines GLx are sequentially scanned. As a result, new data having a reversal potential is written into the nodes PIX of the memory circuits MR100 line-sequentially.

Meanwhile, in a case where a liquid crystal capacitor is AC driven in the memory mode, the polarity of the common electrode COM is reversed in accordance with a timing in which a first gate line GLx (i.e., a gate line GLx1 in a 1st row in FIG. 13) of the entire write-in period is scanned. Consequently, in some memory circuit MR100, only the potential of the common electrode COM is reversed while new data having a reversal potential is not written to the node PIX. Accordingly, in such a memory circuit MR100, a voltage applied to the liquid crystal capacitor Clc is suddenly changed as shown by the dotted lines A of FIG. 13. In FIG. 13, the memory circuit MR100 in which such phenomenon described above is generated corresponds to each of the memory circuits driven by the 2nd gate line GLx2 to the 480th gate line GLx480. The node PIX of the memory circuit MR100 holds the data until new data having a reversal potential is written.

As a result, the screen noise (for example, a pixel which displays white during the refresh period is suddenly changed to black during the entire write-in period) is generated during a period in which only a polarity of the potential of the common electrode COM is reversed while a polarity of the potential of the node PIX in the memory circuit MR100 is not reversed, i.e., while the node PIX is in a floating state, as shown by the dotted lines A of FIG. 13.

As described above, in the conventional memory-type liquid crystal display device, a memory mode enters from the refresh period to the entire write-in period, and then a potential of the common electrode is reversed while the pixel electrode is in a floating state. As a result, the screen noise is generated in the conventional memory-type liquid crystal display device.

The present invention has been made in view of the conventional problems, and an object of the present invention is to provide (i) a display device capable of preventing screen noise, which noise is caused such that a potential of a common electrode is reversed after a memory mode enters from a refresh period to an entire write-in period, and (ii) a method for driving the display device.

### Solution to Problem

In order to attain the aforementioned object, a display device of the present invention includes: a display panel including memory circuits arranged in a matrix manner and a common electrode, the display device having a memory mode in which display is carried out with display data written and held in the memory circuits, the display data being held in the memory circuits by being refreshed, the memory mode including (i) an entire write-in period in which a potential of the common electrode is fixed and the display data is written into all the memory circuits in each row and (ii) a refresh period in which the display data which has been written during the entire write-in period is refreshed at least once while the common electrode is driven, in the memory mode, the potential of the common electrode during the entire write-in period being a potential which the common electrode having been driven had at the end of a refresh period preceding the entire write-in period.

Further, in order to attain the aforementioned object, a method for driving a display device of the present invention, which (i) includes a display panel including memory circuits arranged in a matrix manner and a common electrode and (ii) has a memory mode in which display is carried out with display data written and held in the memory circuits, the display data being held in the memory circuits by being refreshed, wherein: the method includes causing the memory mode to provide (i) an entire write-in period in which a potential of the common electrode is fixed and the display data is written into all the memory circuits in each row and (ii) a refresh period in which the display data which has been written during the entire write-in period is refreshed at least once while the common electrode is driven; and the method includes, in the memory mode, causing the common electrode to hold a potential during the entire write-in period following the refresh period, the potential having been changed by being driven at the end of the refresh period.

Screen noise would be generated conventionally in a case where a liquid crystal capacitor is AC driven in the memory mode. The reason is as follows: when the polarity of the common electrode is reversed during the entire write-in period following the refresh period, specifically, at a timing in which data is written into a first row, a voltage applied to the liquid crystal capacitor, which voltage corresponds to a voltage of a pixel electrode in a floating state, is suddenly changed.

In contrast, the aforementioned arrangement is formed such that, in the memory mode, the common electrode holds a potential during the entire write-in period following the refresh period, which potential has been changed by being driven at the end of the aforementioned refresh period. That is, the potential of the common electrode is not reversed. Accordingly, the polarity of the common electrode is not reversed while the pixel electrode is in a floating state, and this makes it possible to prevent screen noise.

### Advantageous Effects of Invention

As described above, a display device of the present invention includes: a display panel including memory circuits arranged in a matrix manner and a common electrode, the display device having a memory mode in which display is carried out with display data written and held in the memory circuits, the display data being held in the memory circuits by being refreshed, the memory mode including (i) an entire write-in period in which a potential of the common electrode is fixed and the display data is written into all the memory circuits in each row and (ii) a refresh period in which the display data which has been written during the entire write-in period is refreshed at least once while the common electrode is driven, in the memory mode, the potential of the common electrode during the entire write-in period being a potential which the common electrode having been driven had at the end of a refresh period preceding the entire write-in period.

Therefore, in the memory mode, the common electrode is not reversed during the entire write-in period following the refresh period while the pixel electrode is in a floating state. Accordingly, the polarity of the common electrode is not reversed while the pixel electrode is in a floating state, and this makes it possible to prevent screen noise.

### BRIEF DESCRIPTION OF DRAWINGS

FIG. 1 is a block diagram showing an arrangement of a liquid crystal display device according to an embodiment of the present invention.

FIG. 2 is a view showing kinds of driving method included by the liquid crystal display device.

FIG. 3 is a timing chart showing various signal waveforms of the liquid crystal display device in a normal mode.

FIG. 4 is a timing chart showing various signal waveforms of the liquid crystal display device in a memory mode.

FIG. 5 is a block diagram showing a conceptual arrangement of a pixel memory of the liquid crystal display device.

FIG. 6 is a view showing a data holding operation of the pixel memory in a memory mode: (a) of FIG. 6 shows data transition during an entire write-in period; and (b) to (h) of FIG. 6 each shows data transition during a refresh period.

FIG. 7 is an equivalent circuit diagram showing an example of an electric configuration of the pixel memory.

FIG. 8 is a timing chart showing various signal waveforms of the pixel memory in a memory mode.

FIG. 9 is a timing chart showing various signal waveforms of the liquid crystal display device in a case where screen noise is generated after a memory mode enters from a refresh period to an entire write-in period.

FIG. 10 is a timing chart showing various signal waveforms of the liquid crystal display device in a case where an operation for preventing screen noise is carried out when a memory mode enters from a refresh period to an entire write-in period.

FIG. 11 is an equivalent circuit diagram showing an electric configuration of a pixel memory of a conventional liquid crystal display device.

FIG. 12 is a timing chart showing various signal waveforms of a pixel memory of a conventional liquid crystal display device in a memory mode.

FIG. 13 is a timing chart showing various signal waveforms of the conventional liquid crystal display device in a case where screen noise is generated after a memory mode enters from a refresh period to an entire write-in period.

FIG. 14 shows another embodiment of the present invention, and is a timing chart showing various signal waveforms of the pixel memory of FIG. 11 in a case where an operation for preventing screen noise is carried out when a memory mode enters from a refresh period to an entire write-in period.

### DESCRIPTION OF EMBODIMENTS

### Embodiment 1

An embodiment of the present invention will be described below with reference to the drawings. Note that an arrangement that is not described in this embodiment is the same as in the conventional arts. Further, for the sake of easy explanation, members having the like functions as the members in the drawings of the conventional arts are denoted by the like symbols and description thereof is omitted.

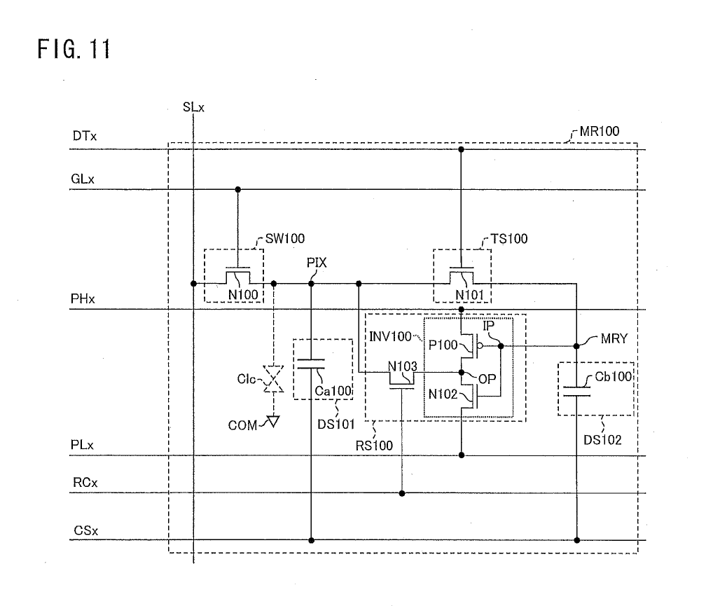

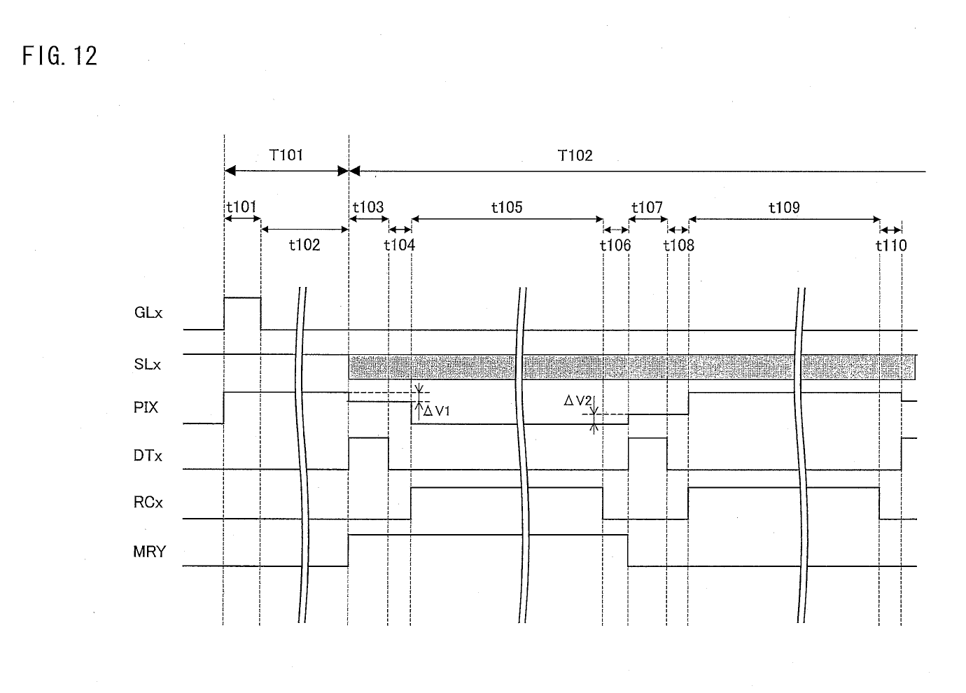

A memory-type liquid crystal display device will be described in the present embodiment. The liquid crystal display device of the present embodiment includes, as a pixel memory, a memory circuit MR100 shown in FIG. 11.

Here, a point to note here is that, in a memory mode, the memory circuit MR100 operates to prevent screen noise which is caused such that a potential of a common electrode COM is reversed after a memory mode enters from a refresh period to an entire write-in period. Such operation of the memory circuit MR100 will be described below.

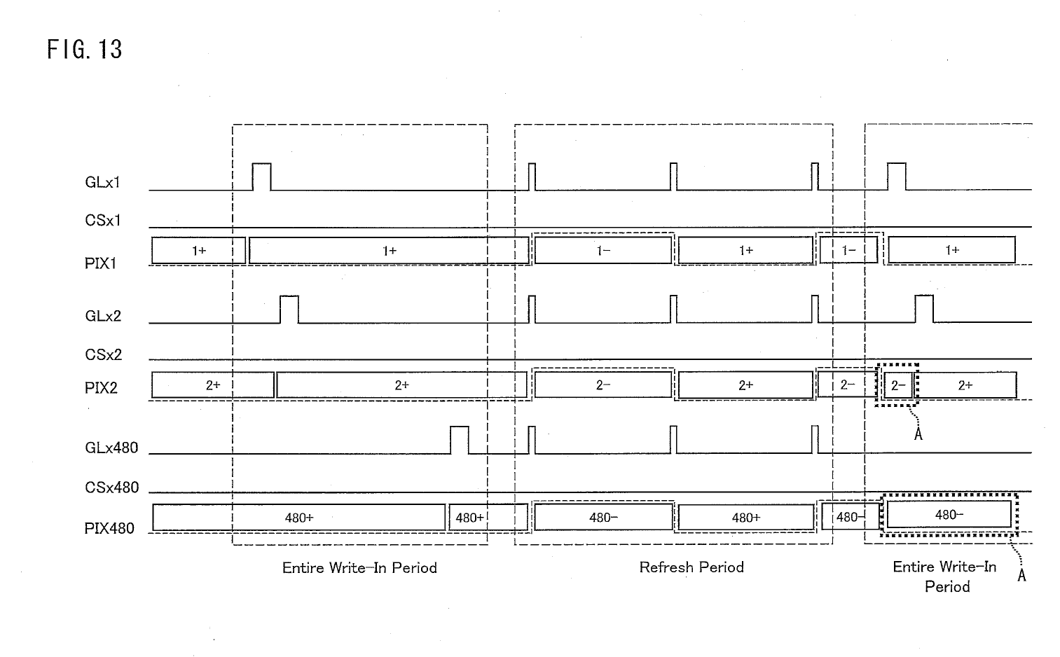

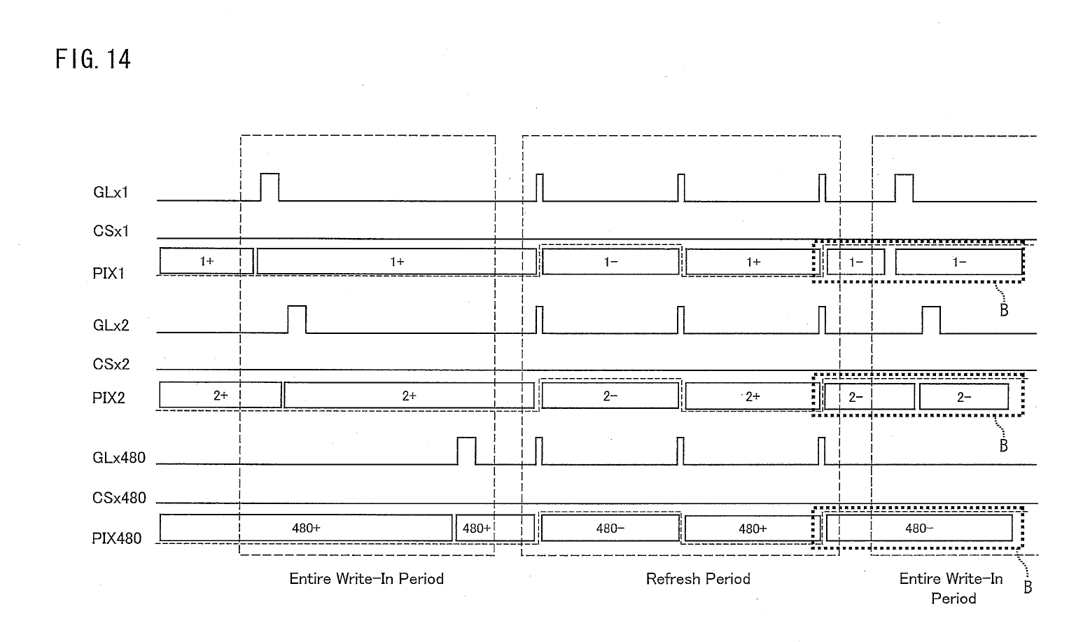

FIG. 14 is a timing chart showing various signal waveforms of the liquid crystal display device of the present embodiment in a case where an operation for preventing screen noise is carried out when a memory mode enters from the refresh period to the entire write-in period. The various signals of FIG. 14 are same as those of FIG. 13.

As shown by the dotted lines B of FIG. 14, in the memory mode during the entire write-in period following the refresh period, the potential of the common electrode COM is set to be a potential which has been reversed in accordance with a timing in which the pixel electrode COM is refreshed at the end of the refresh period. That is, the polarity of the common electrode COM is not reversed during the entire write-in period following the refresh period, i.e., the common electrode COM holds the polarity, which has been refreshed at the end of the refresh period, from the refresh period to the entire write-in period.

Accordingly, the polarity of the common electrode COM is not reversed during a period in which a node PIX of the memory circuit MR100 is in a floating state. This makes it possible to prevent screen noise.

That is, the liquid crystal display device of the present embodiment may include: a liquid crystal panel including memory circuits MR100 arranged in a matrix manner and a common electrode COM, the liquid crystal display device having a memory mode in which display is carried out with display data written and held in the memory circuits MR100, held in the memory circuits by being refreshed, the memory mode including (i) an entire write-in period in which a potential of the common electrode COM is fixed and the display data is written into all the memory circuits MR100 in each row and (ii) a refresh period in which the display data which has been written during the entire write-in period is refreshed at least once while the common electrode COM is driven, in the memory mode, the potential of the common electrode COM during the entire write-in period being a potential which the common electrode COM having been driven had at the end of a refresh period preceding the entire write-in period.

Therefore, in the memory mode, the common electrode COM is not reversed during the entire write-in period following the refresh period while the pixel electrode COM is in a floating state. This makes it possible to prevent screen noise.

### Embodiment 2

Another embodiment of the present invention will be described below with reference to the drawings.

In a memory circuit MR100 shown in FIG. 11, a data transfer section TS100 constituted by a transistor N101 is provided to a circuit for refreshing data. Therefore, a node MRY is separated from a node PIX, and then enters a floating state during a refresh period T102, specifically, during periods t104 to t106 and t108 to t110 each in which a potential of a data transfer control line DTx is inactive (here, the potential is low).

In particular, during the periods t105 to t106, the node MRY has a high potential whereas the node PIX has a low potential. Further, during the periods t109 to t110, the node MRY has a low potential whereas the node PIX has a high potential. The transistor N101 is in an OFF state during those periods, however, the potential of the node MRY is gradually changed as time passes due to an off-leakage current of the transistor N101.

Note that each node in a floating state is influenced by a potential change caused by parasitic capacitance of a transistor, line, etc. However, for the sake of easy explanation, the potential change caused by the parasitic capacitance is excluded from consideration.

Assuming that a is a potential change of the node MRY due to the off-leakage current, the potential of the node MRY during the periods t103 to t105 can be expressed as (high potential−ΔV1−α), which means that the potential of the node MRY causes not only a potential change ΔV1 by distributing electric charges but also a further potential change. In other words, the potential of the node MRY causes a potential change of (ΔV1+α) in total. Meanwhile, the potential of the node MRY during the periods t107 to t109 can be expressed as (low potential+ΔV2+α). The potential of the node MRY generates a potential change ΔV2 by distributing electric charges, and in addition, generates a further potential change. In other words, the potential of the node MRY causes a potential change of (ΔV2+α) in total.

Assuming that (i) threshold voltages of a transistor P100 and a transistor N102, which constitute an inverter INV100, are Vth and (ii) the potential of the node MRY, obtained from the following expression (high potential−ΔV1−α), falls below a potential obtained from the following expression (high potential−Vth), the transistor P100 is gradually turned on. In this case, the transistor N102 is in an on state. Thus, a through current flows from a high electric power supply PHx to a low electric power supply PLx via the transistor P100 and the transistor N102. This causes a large amount of consumption current.

Further, in a state in which such through current flows between the high electric power supply PHx and the low electric power supply PLx, an output of the inverter INV100 gradually becomes a potential between high potential and low potential. Accordingly, the potential of the node PIX becomes a potential between high potential and low potential. When a level (high or low) of the potential of the node PIX is undetectable, the memory circuit MR100 causes a malfunction.

Similarly, in a case where a potential of the node MRY, obtained from the following expression (low potential+ΔV2+α), exceeds a potential obtained from the following expression (low potential+Vth), the transistor N102 is gradually turned on. In this case, the transistor P100 is an on state. Thus, a through current flows from a high electric power supply PHx to a low electric power supply PLx. This causes a large amount of consumption current. When the level (high or low) of the potential of the node PIX is undetectable, the memory circuit MR100 causes a malfunction.

In the liquid crystal display device including the memory circuit MR100 including: a pixel electrode (node PIX) to which a data potential is written; the memory electrode to which an electric charge is transferred from the pixel electrode in order to refresh a potential of the pixel electrode; and a transfer element (transistor N101) provided between the pixel electrode and the memory electrode, there is such a problem, as described above, that when the off-leakage current exists in a data transfer element of the memory circuit, the memory circuit MR100 cannot cause a circuit for carrying out a refresh operation to operate appropriately on the basis of a potential of a memory electrode (node MRY) because of the existence of the off-leakage current.

It is, therefore, desired to provide a liquid crystal display device including a memory circuit which causes a circuit for carrying out a refresh operation to operate an original operation appropriately, even if the off-leakage current exist in the transfer element.

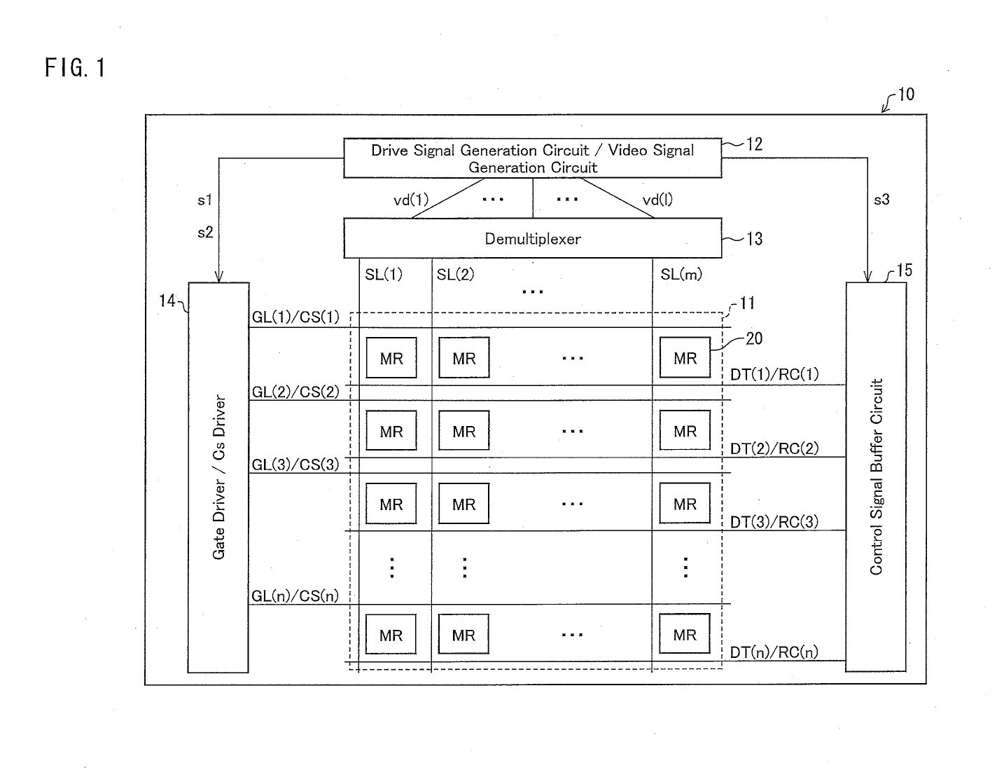

FIG. 1 is a block diagram showing an arrangement example of a liquid crystal display device 10 according to the present embodiment.

The liquid crystal display device 10 is a memory-type liquid crystal display device, and includes, as shown in FIG. 1, a pixel array 11, a drive signal generation circuit/video signal generation circuit 12, a demultiplexer 13, a gate driver/CS driver 14, and a control signal buffer circuit 15.

The pixel array 11 is arranged so that pixel memories 20 (represented by “MR” in FIG. 1) are provided in a matrix manner of n-rows and m-columns. Further, the pixel array 11 is arranged so that a gate line GL(i) (scanning signal line), a storage capacitor line CS(i), a data transfer control line DT(i) (data transfer line), and a refresh output control line RC(i) (refresh output line) are provided in each row of a pixel matrix, and a source line SL(j) (data signal line) is provided in each column of the pixel matrix. Note that “i” is an integer within a range of 1≦i≦n, and “j” is an integer within a range of 1≦j≦m.

Each of the pixel memories 20 has a memory function to hold data independently. Writing and holding a data signal with respect to a pixel memory 20 positioned on an intersection of an i-th row and an j-th column is controlled by the gate line GL(i) connected to the i-th row, the storage capacitor line CS(i), the data transfer control line DT(i), the refresh output control line RC(i), and the source line SL(j) connected to the j-th column.

The drive signal generation circuit/video signal generation circuit 12 is a control and drive circuit for controlling and driving, on the basis of a driving method, (i) supply of a video signal (data signal) to the pixel memory 20 and (ii) operations of the gate driver/CS driver 14 and the control signal buffer circuit 15. The drive signal generation circuit/video signal generation circuit 12 has functions same as those of a display data processing circuit, an input and output interface, a command decoder, a timing controlling circuit, etc. Further, the drive signal generation circuit/video signal generation circuit 12 inputs and outputs data between the liquid crystal display device 10 and the outside of the liquid crystal display device 10, and receives, from the outside, command data for writing or/and holding data and display data. The drive signal generation circuit/video signal generation circuit 12 generates, on the basis of the display data thus received, a data signal to be supplied to the pixel array 11, and then outputs the data signal to an output signal line vd(k) (“k” is an integer within a range of 1≦k≦1<m) from a video output terminal. The drive signal generation circuit/video signal generation circuit 12 interprets the command data thus received and selects a driving method in accordance with the command, and then generates (i) signals s1 and s2 for driving and controlling the gate driver/CS driver 14 and (ii) a signal s3 for driving and controlling the control signal buffer circuit 15, thereby outputting the signals s1, s2, and s3.

Examples of such driving methods encompass a “normal mode” and a “memory mode”, as described below. In the normal mode, the drive signal generation circuit/video signal generation circuit 12 outputs the signal s1 to the gate driver/CS driver 14 while outputting, to the output signal line vd(k), a multiple tone video signal serving as a data signal. In the memory mode, the drive signal generation circuit/video signal generation circuit 12 outputs the signal s2 and the signal s3 to the gate driver/CS driver 14 and the control signal buffer circuit 15, respectively, while outputting, to the output signal line vd(k), the binary data serving as a data signal.

Note that a clock signal as a base for timing may be supplied from an external system. Alternatively, the clock signal may be generated by an oscillator or the like inside the liquid crystal display device 10 or inside the drive signal generation circuit/video signal generation circuit 12. Further, the drive signal generation circuit/video signal generation circuit 12 can also serve as a circuit for generating not only a timing used for a memory operation, but also a timing used for a display operation, such as a gate start pulse, a gate clock, a source start pulse, a source clock, and the like.

The demultiplexer 13 allots an output, supplied from the output signal line vd(k), to a corresponding source line SL(j).

The gate driver CS driver 14 is a circuit for driving and controlling a write-in operation of the pixel memory 20 of the pixel array 11 via the gate line GL(i) and the storage capacitor line CS(i). The gate driver/CS driver 14 controls the gate line GL(i) and the storage capacitor line CS(i) on the basis of the signals s1 and s2 supplied from the drive signal generation circuit/video signal generation circuit 12.

The control signal buffer circuit 15 is a circuit for driving and controlling a data holding operation of the pixel memory 20 of the pixel array 11 via the data transfer control line DT(i) and the refresh output control line RC(i). The control signal buffer circuit 15 controls the data transfer control line DT(i) and the refresh output control line RC(i) on the basis of the signal s3 supplied from the drive signal generation circuit/video signal generation circuit 12.

Further, the pixel array 11 is formed on a substrate (not shown) in the liquid crystal display device 10. Note that the drive signal generation circuit/video signal generation circuit 12, the demultiplexer 13, the gate driver/CS driver 14, and the control signal buffer circuit 15 may be formed monolithically on the substrate.

Further, the liquid crystal display device 10 includes, on a position facing the substrate, a counter substrate (not shown) including a common electrode (counter substrate) COM. The substrate and the counter substrate are provided so as to sandwich a liquid crystal, and such arrangement constitutes a liquid crystal panel (hybrid-memory liquid crystal panel) (display panel).

A common voltage Vcom to be applied to the common electrode COM may be supplied from a Vcom driver provided in the liquid crystal display device 10, or may be directly driven from the outside of the liquid crystal display device 10. Note that the common electrode COM may be provided on the substrate.

Further, a liquid crystal capacitor Clc is provided between the pixel electrode of the pixel memory 20 and the common electrode COM via a liquid crystal. A voltage based on a potential difference between the pixel electrode and the common electrode COM is applied to the liquid crystal capacitor Clc. In this way, an image can displayed.

Note that, as is clearly seen from the aforementioned description, the drive signal generation circuit/video signal generation circuit 12 and the demultiplexer 13 constitute a column driver, meanwhile, the gate driver/CS driver 14 and the control signal buffer circuit 15 constitute a row driver. However, the column driver may be formed in a case where a CS driver drives the control signal buffer circuit 15 and all storage capacitor lines CS(i) simultaneously. Further, the control signal buffer circuit 15 and all storage capacitor lines CS(i) may be driven, by the CS driver, directly from the outside of the liquid crystal display device 10.

Hereinafter, the gate line GL(i), the storage capacitor line CS(i), the data transfer control line DT(i), the refresh output control line RC(i), and the source line SL(j) are collectively called “gate line GL”, “storage capacitor line CS”, “data transfer control line DT”, “refresh output control line RC”, and “source line SL”, respectively.

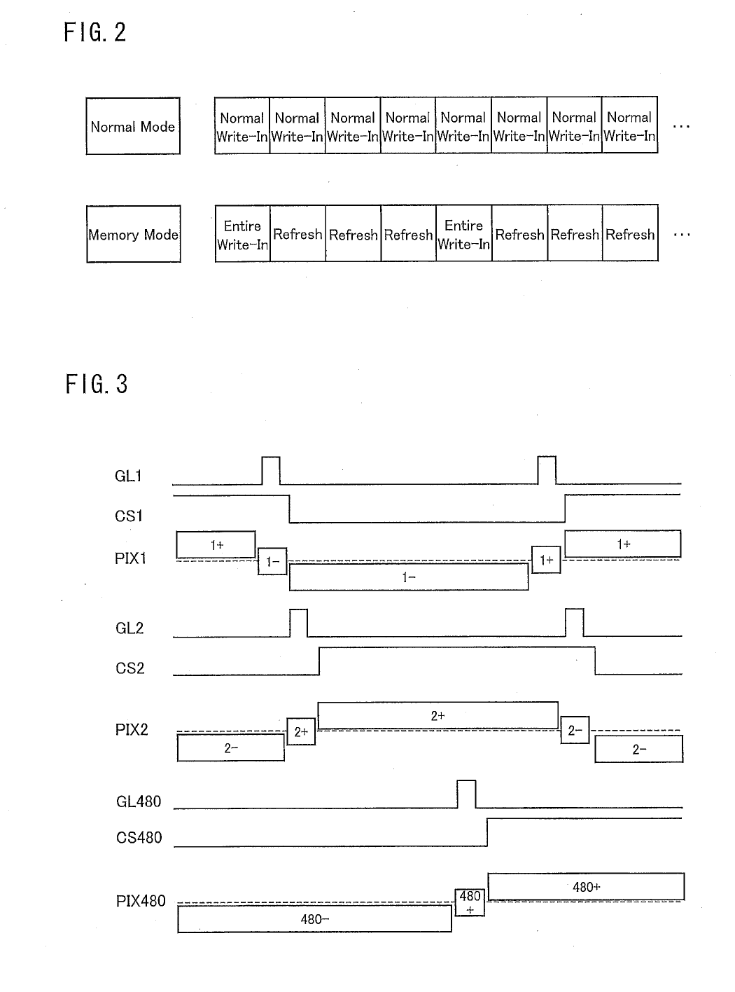

As shown in FIG. 2, the liquid crystal display device 10 having the aforementioned arrangement, includes the “normal mode” and the “memory mode” as the driving methods for displaying an image. FIG. 2 shows kinds of driving method included by the liquid crystal display device 10.

In the normal mode, AC driving for displaying a video image or a still image with multiple tones is carried out on the basis of multiple tone video signals supplied to the memory circuits per frame. In the normal mode, a normal write-in period for writing multiple tone video signals for one frame period is repeated.

FIG. 3 is a timing chart showing various signal waveforms of the liquid crystal display device 10 in a normal mode. The timing chart of FIG. 3 shows a case where the pixel memories 20 are arranged in 480 rows and m column(s) (n=480). For the sake of easy illustration, the timing chart shows signal waveforms of elements in 1st, 2nd, and 480th rows. GL1, GL2, and GL480 indicate potentials of the gate lines GL in 1st, 2nd, 480th rows, respectively. CS1, CS2, and CS480 indicate potentials of the storage capacitor lines CS in 1st, 2nd, 480th rows, respectively. PIX1, PIX2, and PIX480 indicate potentials of pixel electrodes of the pixel memories 20 in 1st, 2nd, 480th rows, respectively. Further, the dotted lines, which are shown to be overlapped with the signal waveforms of PIX1, PIX2, and PIX480, indicate a potential of the common electrode COM.

During the normal write-in period, the multiple tone video signals, which have been outputted to the source lines SL at the same time, are written into the pixel memories 20 in one row selected by scanning of the gate line GL, and other rows are written line-sequentially in the same way. FIG. 3 shows a case where the 1st row (serving as a start row) to the 480th row (serving as an end row) are sequentially selected. Further, during the normal write-in period, writing to the pixel memories 20 is carried out by 1H (i.e., one horizontal period) reverse driving. In addition, CC (charge coupling) driving is also carried out, so that a potential of the common electrode COM becomes constantly, and potentials of the storage capacitor line CS are reversed, between a high potential and a low potential, in accordance with a timing in which data is written into corresponding pixel memories 20.

Note that, in the normal mode, the data holding operation of each of the pixel memories 20 is inactive. The control signal buffer circuit 15 does not allow potentials of the data transfer control line DT and potentials of the refresh output control line RC to influence the pixel electrode and the liquid crystal capacitor Clc. Therefore the liquid crystal display device 10 can attain to function in the same way as a liquid crystal display device having no memory function.

In the memory mode, AC driving for displaying an image which hardly changes as time passes (such as a still image) is carried out on the basis of the binary data which is held by carrying out the data holding operation of the pixel memory 20, and which determines a tone regarding whether the image is bright or dark (black or white). The binary data is data (data signal) having any one of a high potential and a low potential. The memory mode includes an entire write-in period and a refresh period. The entire write-in period is a period in which data to be held is written per row into the pixel memories 20, and the refresh period is a period in which the data written during the entire write-in period is held by refreshing the data.

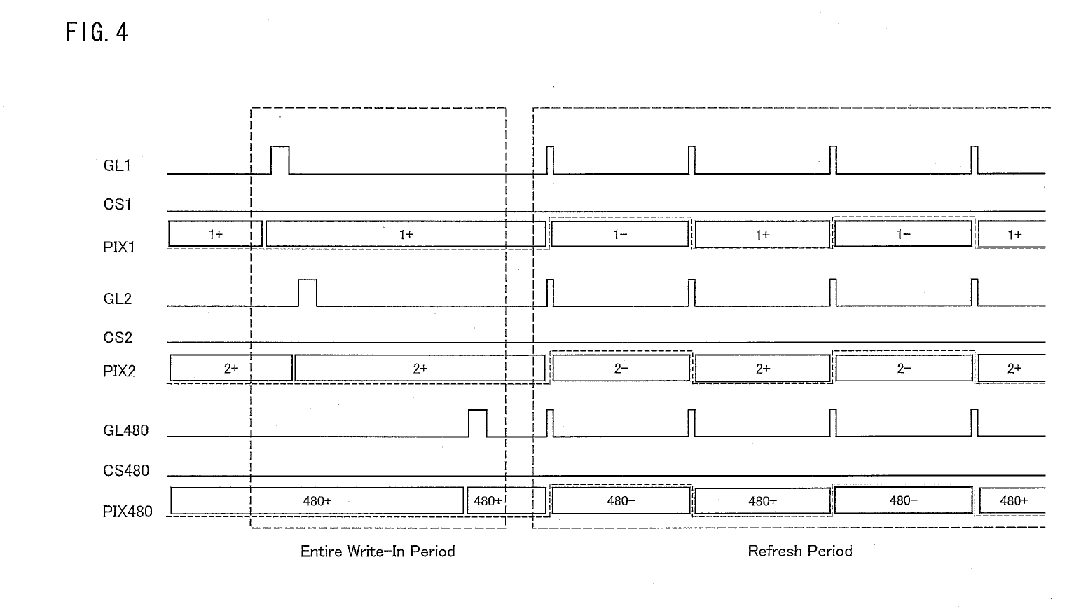

FIG. 4 is a timing chart showing various signal waveforms of the liquid crystal display device 10 in the memory mode. The various signals of FIG. 4 are same as those of FIG. 3.

During the entire write-in period, the binary data, which has been outputted to the source lines SL simultaneously, is written into the pixel memories 20 in one row selected by scanning of the gate lines GL, and other rows are written line-sequentially in the same way. Note that, in the present embodiment, the data writing into the pixel memories 20 provided in different rows should be such that a period for writing data in one row is set so as not to be overlapped with that in any other row, because the rows corresponding to writing addresses of the pixel array 11 are driven line-sequentially. Therefore, during the entire write-in period, a period in which the data is actually written is different between rows. FIG. 4 shows a case where the rows are sequentially selected from the 1st row as a start row to the 480th row as an end row.

However, during the entire write-in period, the gate lines GL in different rows may be scanned at the same time if the scanning of the gate lines GL is successively terminated to change, between the rows, a timing of writing of the data to the pixel memories 20. For example, a method for scanning the gate lines GL every two rows, skipping one row, may be used. In this case, a timing of scanning of one row may be overlapped with that of any other row, however, a timing in which scanning of the gate line is terminated is different between the rows.

Further, 1V (one vertical period) reverse driving is carried out during the entire write-in period, and polarities of voltages applied to all the liquid crystal capacitors Clc are the same. When writing data to the pixel electrodes, the potential of the common electrode COM and the potentials of the storage capacitor lines CS are fixed to any one of the high potential and the low potential (low potential in FIG. 4).

The writing of data to all the pixel memories 20 is terminated during the entire write-in period, and after that, all the pixel memories 20 enters the refresh period simultaneously. That is, all the pixel memories 20 carry out the refresh operation at the same time. During the refresh period, the data written into the pixel memories 20 during the entire write-in period is refreshed at least once, and, when the data is refreshed, a level of the data is shifted (high to low, or low to high). The potential of the common electrode COM is reversed between a high potential and a low potential in accordance with the refresh operation of the data. The potentials of the storage capacitor lines CS are fixed to be low.

Note that, in the memory mode, the refresh period may be repeated any number of times. For example, in a case where the refresh period is repeated as shown in FIG. 2, the number of writing per a predetermined period in the memory mode is reduced to ¼ in comparison with that in the normal mode.

Further, in the memory mode, the binary data is written into each of the pixel memories 20. Therefore, in a case where no color is allotted to the pixel memories, the resulting display is a black and white display. Meanwhile, in a case where color filters or the like are allotted to the pixel memories 20, the number of colors is obtained from the power of the number of colors with respect to 2. For example, the pixel memories 20, each of which is allotted with R (red), G (green), or B (blue), constitute one pixel, the pixel memories 20 display eight colors display, because the cube of 2 is 8.

Here, one of points to note here is the data holding operation of the pixel memories 20 in the memory mode. Hereinafter, a concept of the data holding operation of the pixel memories 20 will be described below, and after that, a concrete arrangement of the pixel memories 20 and the data holding operation will be described. Note that, for the sake of easy explanation, only one pixel memory 20 on the pixel array 11 will be exemplified, however, all the pixel memories 20 have the same function.

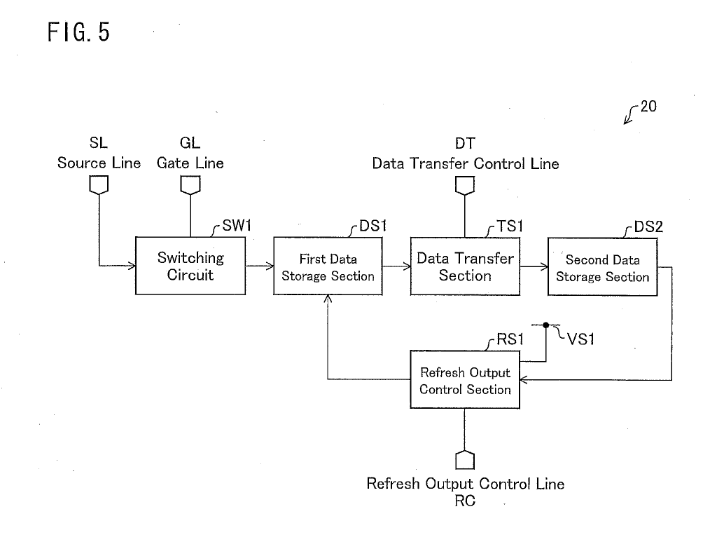

FIG. 5 shows a conceptual arrangement of the pixel memory 20. The pixel memory 20 includes a switching circuit SW1, a first data storage section DS1, a data transfer section TS1, a second data storage section DS2, a refresh output control section RS1, and a supply source VS1 (potential supply-source).

The gate driver/CS driver 14 drives the switching circuit SW1 via the gate line GL in order to selectively carry out electrical connection of the source line SL and the first data storage section DS1 or electrical disconnection thereof.

The first data storage section DS1 receives and holds the binary data.

The control signal buffer circuit 15 drives the data transfer section TS1 so as to selectively carry out a transfer operation or a non-transfer operation. The transfer operation is an operation in which the binary data is transferred to the second data storage section DS2 while the binary data is kept held in the first data storage section DS1. Meanwhile, the transfer is not carried out in the non-transfer operation. Note that the data transfer control lines TS1 for all the pixel memories 20 are supplied with a common potential, so that the data transfer control lines DT are unnecessarily provided in all rows and driven by the control signal buffer circuit 15. It is therefore possible to drive the data transfer control line DT with use of the gate driver/CS driver 14 or the like.

The second data storage section DS2 receives and holds the binary data.

The control signal buffer circuit 15 drives the refresh output control section RS1 via the refresh output control line RC so as to selectively control the refresh output control section RS1 to carry out a first operation or a second operation. Note that potentials supplied to the refresh output control lines RC of all of the pixel memories 20 are the same, so that the refresh output control lines RC are unnecessarily provided in all the rows and driven by the control signal buffer circuit 15. It is therefore possible to drive the data transfer control line DT with use of the gate driver/CS driver 14 or the like.

The first operation is an operation for selecting an active state or an inactive state in accordance with control information indicating which one of a high potential or a low potential the binary data held in the second data storage section DS2 is. The active state is a state in which an input is received by the refresh output control section RS1 and the refresh output control section RS1 supplies the input, as an output from the refresh output control section RS1, to the first data storage section DS1. The inactive state is a state in which the refresh output control section RS1 stops supplying the output. The second operation is an operation for causing the refresh output control section RS1 to stop supplying the output, irrespective of the control information.

The supply source VS1 supplies a predetermined voltage to the input of the refresh output control section RS1.

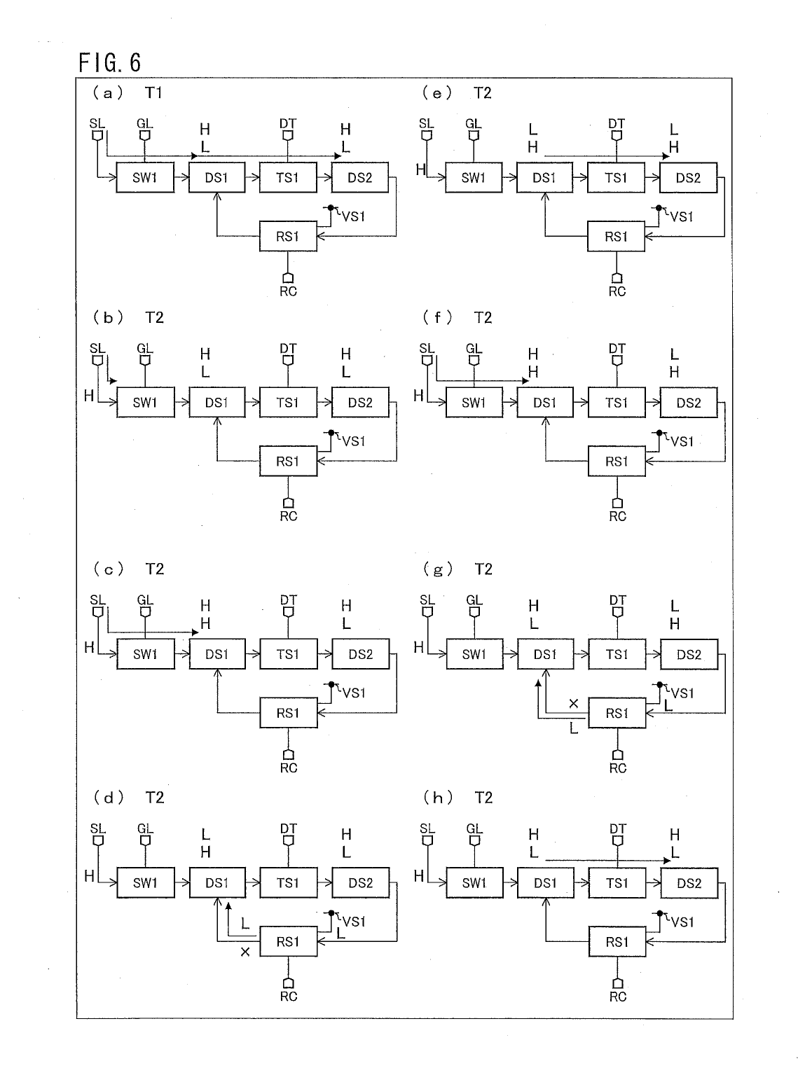

FIG. 6 is a view showing a data holding operation of the pixel memory 20 in a memory mode: (a) of FIG. 6 shows data transition in an entire write-in period; and (b) to (h) of FIG. 6 each shows data transition in a refresh period T2. In FIG. 6, “H” is shown as a high potential (first potential), and “L” is shown as a low potential (second potential). Further, there are parts where both “H” and “L” are written adjacently in the vertical direction. In such parts, upper parts indicate a transition state of the potential when “H” is written into the pixel memory 20, and lower parts indicate a transition state of the potential when “L” is written into the pixel memory 20.

In the memory mode, first, an entire write-in period T1 is started.

As shown in (a) of FIG. 6, during the entire write-in period T1, the switching circuit SW1 is turned on by the gate line GL, and data to be held is supplied from the source line SL to the first data storage section DS1 via the switching circuit SW1, which data is represented as the first potential or the second potential.

In a case where the data is supplied to the first data storage section DS1, the switching circuit SW1 is turned off by the gate line GL. Further, in this case, the data transfer section TS1 is turned on by the data transfer control line DT, i.e., the data transfer control line DT causes the data transfer section TS1 to carry out the transfer operation. The data thus supplied to the first data storage section DS1 is transferred from the first data storage section DS1 to the second data storage section DS2 via the data transfer section TS1 while the data is kept held in the first data storage section DS1. After the data is transferred to the second data storage section DS2, the data transfer section TS1 is turned off, i.e., carries out the non-transfer operation.

Next, the refresh period T2 is started after the entire write-in period T1.

During the refresh period T2, the first potential data is firstly outputted to the source line SL, as shown in (b) of FIG. 6.

Then, as shown in (c) of FIG. 6, the switching circuit SW1 is turned on by the gate line GL, and the first potential data is inputted to the first data storage section DS1 from the source line SL via the switching circuit SW1. After the first potential data is inputted to the first data storage section DS1, the switching circuit SW1 is turned off by the gate line GL.

Next, as shown in (d) of FIG. 6, the refresh output control line RC controls the refresh output control section RS1 to carry out the first operation. The first operation of the refresh output control section RS1 differs depending on which one of the first potential data or second potential data is held in the second data storage section DS2.

Specifically, in a case where the first potential data is held in the second data storage section DS2, first control information indicating that the first potential data is held in the second data storage section DS2 is transferred from the second data storage section DS2 to the refresh output control section RS1, and accordingly, the refresh output control section RS1 enters the active state. In the active state, the refresh output control section RS1 receives an input, and supplies the input, section RS1, to the first data storage section DS1.

In a case where the refresh output control section RS1 carries out the first operation, a potential of the supply source VS1 is set so that the second potential data is supplied to the input of the refresh output control section RS1 at least at the end of a period in which the first control information is transferred to the refresh output control section RS1. In this case, the second potential data, supplied from the refresh output control section RS1, is held in the first data storage section DS1 by overwriting the second potential data with the data which has been held in the first data storage section DS1.

Meanwhile, in a case where the second data storage section DS2 holds the second potential data, the refresh output control section RS1 enters the inactive state. In the inactive state, second control information indicating that the second potential data is held in the second data storage section DS2 is transferred from the second data storage section DS2 to the refresh output control section RS1, and accordingly, the refresh output control section RS1 stops supplying the output (indicated by “x” in FIG. 6). In this case, the first data storage section DS1 keeps holding the first potential data.

After that, the refresh output control line RC controls the refresh output control section RS1 to carry out the second operation.

Then, as shown in (e) of FIG. 6, during the refresh period T2, the data transfer control line DT causes the data transfer section TS1 to carry out the transfer operation. The data which has been held in the first data storage section DS1 so far is transferred to the second data storage section DS2 from the first data storage section DS1 via the data transfer section TS1 while the data is kept held in the first data storage section DS1. After the data is transferred to the second data storage section DS2 from the first data storage section DS1, the data transfer section TS1 is turned off, i.e., carries out the non-transfer operation.

Then, as shown in (f) of FIG. 6, the switching circuit SW1 is turned on by the gate line GL, and the first potential data is inputted to the first data storage section DS1 from the source line SL via the switching circuit SW1. After the first potential data is inputted to the first data storage section DS1, the switching circuit SW1 is turned off by the gate line GL.

Next, as shown in (d) of FIG. 6, the refresh output control line RC controls the refresh output control section RS1 to carry out the first operation. In a case where the second data storage section DS2 holds the first potential data, the refresh output control section RS1 enters the active state, and carries out an operation in which the second potential data, which is supplied from the supply source VS1, is supplied to the first data storage section DS1.

In this case, the second potential data, supplied from the refresh output control section RS1, is held in the data storage section DS1 by overwriting the second potential data on the data which has been held in the data storage section DS1. Meanwhile, in a case where the second data storage section DS2 holds the second potential data, the refresh output control section RS1 enters the inactive state, i.e., the refresh output control section RS1 stops supplying the output.

Then, as shown in (h) of FIG. 6, the data transfer control line DT causes the data transfer section TS1 to carry out the transfer operation. The data which has been held in the first data storage section DS1 so far is transferred to the second data storage section DS2 from the first data storage section DS1 via the data transfer section TS1 while the data is kept held in the first data storage section DS1. After the data is transferred to the second data storage section DS2 from the first data storage section DS1, the data transfer section TS1 is turned off, i.e., carries out the non-transfer operation.

With the series of the aforementioned operations, as shown in (h) of FIG. 6, the data written during the entire write-in period T1 in (a) of FIG. 6 is restored by the first data storage section DS1 and the second data storage section DS2. Therefore, even if the operations shown in (b) to (h) of FIG. 6 are repeated an arbitrary number of times after the operation in (h) of FIG. 6 is carried out, the data written during the entire write-in period T1 can be restored similarly.

In a case where the first potential data (here, the first potential is “H”) is written during the entire write-in period T1, the first potential data is restored such that the potential is refreshed by being reversed once for each of the operations of (d) and (f) of FIG. 6. Meanwhile, in a case where the second potential data (here, the second potential “L”) is written during the entire write-in period T1, the second potential data is restored such that the potential is refreshed by being reversed once for each of the operations (c) and (g) of FIG. 6.

Therefore, with use of the held data, a still image can be displayed in the memory mode while a screen is refreshed. Note that, in a case where the first potential is low potential and the second potential is a high potential, the aforementioned operation logic is reversely carried out.

Further, unlike conventional products, the present invention does not need to provide an inverter for carrying out the refresh operation. This is because, in a case of the refresh operation, the source line SL supplies the first potential data to the first data storage section DS1 as shown in (c) and (f) of FIG. 6, and the refresh output control section RS1 supplies the second potential data to the first data storage section DS1 from the supply source VS1 as shown in (d) and (g) of FIG. 6.

That is, according to the liquid crystal display device 10, after the data is written into the first data storage section DS1 of each pixel memory 20, one of the first potential data and the second potential data is supplied from the source lines SL, while the other of the first potential data and the second potential data is supplied from the supply source VS1, without using the inverter. This arrangement makes it possible to refresh the data written into the each pixel memory 20 while the level of the data is shifted.

Further, in a state in which the data is refreshed, the data of the first data storage section DS1 and the data of the second data storage section DS2 are identical with each other. Thus, even in a case where the data transfer section TS1 carries out the transfer operation, the potential of the first data storage section DS1 and the potential of the second data storage section DS2 do not change. This makes it possible for the first data storage section DS1 and the second data storage section DS2 to hold the refreshed data for a long time, even under the transfer operation of the data transfer section TS1. In this case, the first data storage section DS1 and the second data storage section DS2 are connected to each other via the data transfer section TS1. Accordingly, even if an off-leakage current exists in the transfer element of the data transfer section TS1, the off-leakage current does not influence holding of the data. Further, the data is held, as a whole, in a large electrical capacitor formed as a combination of the first data storage section DS1 and the second data storage section DS2. Because of this, the potential of the data is less apt to change due to an influence of external noise.

Accordingly, even if an off-leakage current exists in the transfer element used in the data transfer section TS1, a potential of a hold node for holding the data of the second data storage section DS2 is held for a long time with a potential of a hold node for holding the data of the first data storage section DS1. The potential of the hold node of the second storage section DS2 is therefore less apt to change. In a conventional pixel memory, after the data is refreshed, the first data storage section DS101 and the second data storage section DS102 hold different data for a long time while they are electrically separated from each other by the transfer element (transistor N101) of the data transfer section TS100, as shown by the periods t105 and t109 of FIG. 39. Accordingly, an off-leakage current in the transfer element has a significant influence on the potential of the second data storage section DS102.

Further, even if the potential of the hold node of the second data storage section DS2 is changed, a period in which the potential of the hold node is being changed is not such a long period that the control information for controlling the refresh output control section RS1 to carry out the first operation is switched between an active level and an inactive level.

Further, if an inverter is provided in the refresh output control section RS1, there are two complementary levels (high level and low level) serving as active levels necessary for operating the inverter. Because of this, a range in which the potential of the second data storage section DS2 serves as a level for causing the inverter to keep one operation stably is narrow. For example, in a case where (i) the potential of the second data storage section DS2 is a low level, (ii) the inverter is operated to turn on a P-channel transistor and to turn off an N-channel transistor, and (iii) a gate potential of the P-channel transistor is slightly increased, there is a risk that the N-channel transistor might be made conductive. In order to avoid such a situation, the N-channel transistor is designed to have a high threshold voltage. In this case, however, when the P-channel transistor is turned off and the N-channel transistor is turned on, a range in which the high level can serve as the active level is narrow.

On the other hand, in the present embodiment, the active level of the refresh output control section RS1 is any one of the first potential and the second potential. A range in which the control information for controlling the refresh output control section RS1 serves as the inactive level is large, and therefore such a risk that the inactive level is switched to the active level is reduced. Meanwhile, it is possible to easily supply the active level from the supply section VS1 to the first data storage section DS1, if only the active level functions in an initial state of the active state of the first operation of the refresh output control section RS1. Accordingly, even if the active level is switched to the inactive level at last, the refresh output control section RS1 is less apt to cause a malfunction.

It is therefore possible to easily realize a design having such a large allowance that the refresh output control section RS1 does not cause a malfunction even if the potential of the hold node of the second data storage section DS2 is changed. For example, consider a case where the control information for controlling the refresh output control section RS1 is inputted to a gate of a transistor. In this case, a design having such a large allowance is such one that the threshold voltage of the transistor is set to be high enough so that a voltage between the gate and a source is less apt to be higher than the threshold voltage of the transistor even if the potential of the second data storage section DS2 is changed from an inactive level at which the potential of the second data storage section DS2 should be kept.

Moreover, even if the potential of the hold node of the second data storage section DS2 is changed, the refresh output control section RS1 does not cause a malfunction during a period in which the refresh output control section RS1 carries out the second operation.

Accordingly, even if an off-leakage current exists in the transfer element used in a transfer section for transferring the binary data between the two data storage sections, it is possible to cause a circuit for carrying out the refresh operation to carry out an original operation appropriately, without an increase in consumption current or a malfunction, on the basis of data held in one of two storage sections.

Next, a concrete arrangement of the pixel memory 20 and the data holding operation will be described in this order with reference to an example.

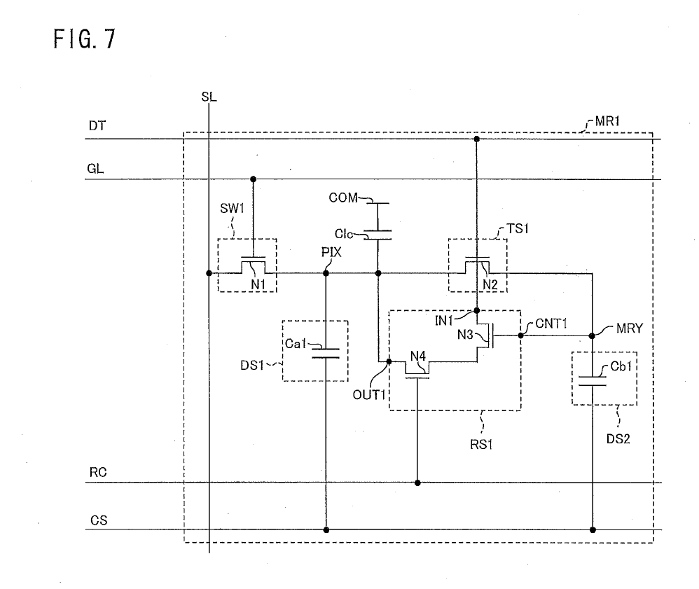

FIG. 7 illustrates a memory circuit MR1, which is an equivalent circuit, as an arrangement example of the pixel memory 20. As shown in FIG. 7, the memory circuit MR1 includes a transistor N1, a transistor N2, a transistor N3 (first switch), a transistor N4 (second switch), a capacitor Ca1 (first capacitor), and a capacitor Cb1 (second capacitor).

Further, a pixel array 11 includes, as lines for driving the memory circuit MR1, a source line SL, a gate line GL, a storage capacitor line CS, a data transfer control line DT, and a refresh output control line RC.

Note that the memory circuit MR1 of FIG. 7 and the arrangement of FIG. 5 correspond to each other, specifically, as follows: the transistor N1 constitutes the switching circuit SW1; the capacitor Ca1 constitutes the first data storage section DS1; the transistor N2 is the transfer element, and constitutes the data transfer section TS1, the capacitor Cb1 constitutes the second data storage section DS2; the transistor N3 and the transistor N4 constitute the refresh output control section RS1. In other words, the memory circuit MR1 includes the switching circuit SW1 (first switching circuit), the first data storage section DS1, the data transfer section TS1 (second switching circuit), the second data storage section DS2, and the refresh output control section RS1 (control section, third switching circuit).

The transistors N1 to N4 are N-channel TFTs (field effect transistors). Therefore, all the transistors constituting the memory circuit MR1 are N-channel TFTs in FIG. 7, so that the memory circuit MR1 can be easily formed on amorphous silicon.

Here, one drain/source terminal of a field effect transistor, such as the aforementioned TFTs, is referred to as “first drain/source terminal”, and the other drain/source terminal is referred to as “second drain/source terminal”.

A gate terminal of the transistor N1 is connected to the gate line GL, a first drain/source terminal thereof is connected to the source line SL, and a second drain/source terminal thereof is connected to a node PIX which is one end of the capacitor Ca1. The other end of the capacitor Ca1 is connected to the storage capacitor line CS. When the transistor N1 is turned on, the switching circuit SW1 enters a conductive state. When the transistor N1 is turned off, the switching circuit SW1 enters a non-conductive state.

A gate terminal of the transistor N2 is connected to the data transfer control line DT, a first drain/source terminal thereof is connected to the node PIX, and a second drain/source terminal thereof is connected to a node MRY which is one end of the capacitor Cb1. The other end of the capacitor Cb1 is connected to the storage capacitor line CS. When the transistor N2 is turned on, the data transfer section TS1 enters a transfer operation state. When the transistor N2 is turned off, the data transfer section TS1 enters a non-transfer operation state. In other words, in a case where the transistor N2 is in an ON state, the node PIX and the node MRY are electrically connected to each other, whereas, in a case where the transistor N2 is an OFF state, the node PIX and the node MRY are made non-conductive to each other.

A gate terminal of the transistor N3, serving as a control terminal CNT1 of the refresh output control section RS1, is connected to the node MRY, a first drain/source terminal serving as an input terminal IN1 of the refresh output control section RS1 is connected to the data transfer control line DT, and a second drain/source terminal is connected to a first drain/source terminal of the transistor N4. In the transistor N3, a potential held in the node MRY serves as a signal for controlling electrical connection of the node PIX and the node MRY or electrical disconnection thereof.

A gate terminal of the transistor N4 is connected to the refresh output control line RC, and a second drain/source terminal serving as an output terminal OUT1 of the refresh output control section RS1 is connected to the node PIX. That is, the transistor N3 and the transistor N4 are connected to each other in series so that the transistor N3 is provided on an input-side of the refresh output control section RS1 between an input and an output of the refresh output control section RS1. In the transistor N4, a potential of the refresh output control line RC serves as a signal for controlling electrical connection of the node PIX and the node MRY and electrical disconnection thereof.

Note that a position of the transistor N3 and a position of the transistor N4 may be replaced to each other in the connection, and what is required is to provide the transistor N3 and the transistor N4 in series between the input and the output of the refresh output control section RS1.

During a period in which the transistor N4 is in an ON state, the refresh output control section RS1 is controlled to carry out the first operation. Meanwhile, during a period in which the transistor N4 is in an OFF state, the refresh output control section RS1 is controlled to carry out the second operation. The transistor N3 is an N-channel TFT. Therefore, in a case where the refresh output control section RS1 carries out the first operation: (i) control information, which causes the refresh output control section RS1 to be the active state, is a high level (active level); or (ii) control information, which causes the refresh output control section RS1 to be the inactive state, is low level (inactive level). In other words, in a case where each of the transistors N3 and N4 is in the ON state, the node PIX and the data transfer control line DT are electrically connected to each other. Meanwhile, in a case where each of the transistors N3 and N4 is in the OFF state, the node PIX and the data transfer control line DT are non-conductive to each other.

The capacitor Ca1 has a capacitance larger than that of the capacitor Cb1. For example, each of the capacitances of the capacitor Ca1 and capacitor Cb1 is set so that a change in the potential of the node PIX (pixel electrode) does not influence the potential of the data (high potential or low potential) even if an electric charge is transferred between the capacitor Ca1 and the capacitor Cb1.

Further, in the memory circuit MR1, a liquid crystal capacitor Clc is connected between the node PIX and the common electrode COM. The node PIX corresponds to a pixel electrode, and the capacitor Ca1 also functions as a storage capacitor of the pixel memory 20.

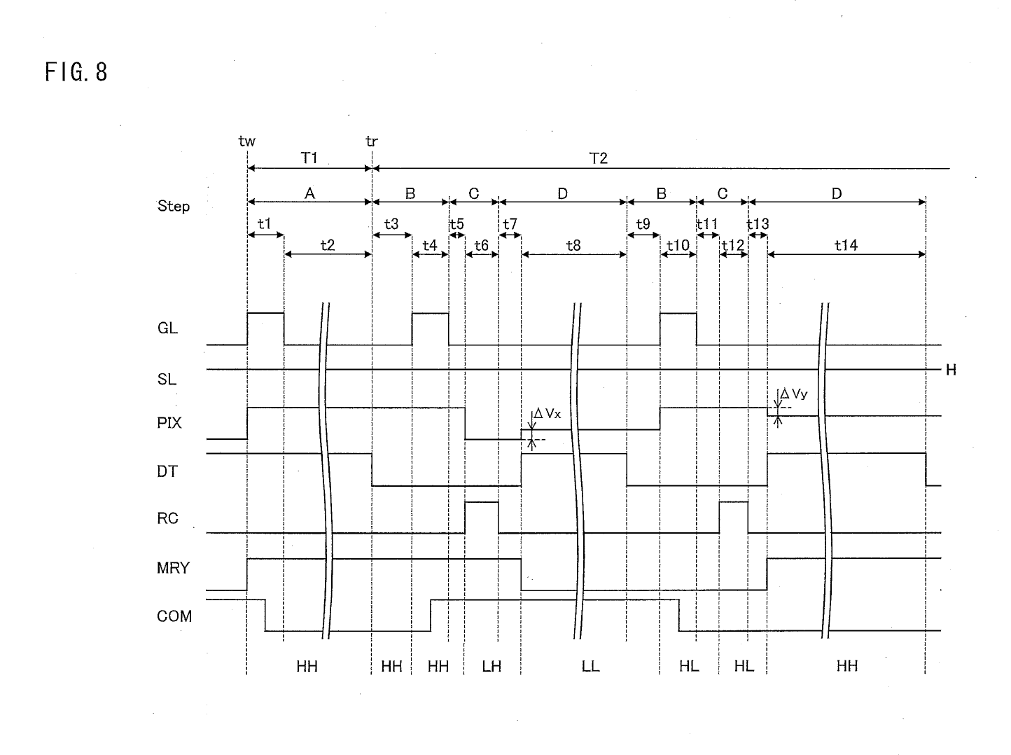

FIG. 8 is a timing chart in a memory mode, showing various signal waveforms of the memory circuit MR1 including the aforementioned arrangement.

FIG. 8 shows a case where high potential data as the first potential data is written into the entire write-in period T1. Further, at a bottom of FIG. 8, a potential of the node PIX (on the left side) and a potential of the node MRY (on the right side) are shown in each of the periods corresponding to (a) to (h) of FIG. 6. Note that FIG. 8 only shows signal waveforms of elements in a row which is firstly scanned. However, the refresh operation is carried out simultaneously with respect to all the rows as described above, so that all the rows have the same signal waveform during the refresh period T2.

The data holding operation is carried out such that: display data and a data storage command are inputted to the drive signal generation circuit/video signal generation circuit 12 from the outside of the liquid crystal display device 10 via a transfer line; and the drive signal generation circuit/video signal generation circuit 12 interprets the data storage command, and then, and is into the memory mode. Specifically, the drive signal generation circuit/video signal generation circuit 12 generates the binary data which is to be supplied to the pixel array 11 on the basis of the display data, and controls the source line SL via an output signal line vd(k) and a demultiplexer 13. At the same time, the drive signal generation circuit/video signal generation circuit 12 generates the signals s2 and s3 based on the memory mode, thereby controlling the gate driver/CS driver 14 and the control signal buffer circuit 15.

In accordance with the signals s2 and s3 supplied from the drive signal generation circuit/video signal generation circuit 12, the gate driver/CS driver 14 and the control signal buffer circuit 15 control the gate line GL, the storage capacitor line CS, the data transfer control line DT, and the refresh output control line RC.

A binary-level potential including the high (active) level and the low (inactive) level is applied to the gate line GL from the gate driver/CS driver 14. The binary-level potentials, each of which includes high or low potential, are applied to the data transfer control line DT and the refresh output control line RC, respectively, from the control signal buffer circuit 15. Level of high or low potential may be set for each line individually. The storage capacitor line CS is fixed to a constant potential by the gate driver/CS driver 14.

The binary data (data signal potential) having a high potential, which is lower than the high potential of the gate line GL, and a low potential is inputted to the source line SL from the demultiplexer 13. The high potential of the data transfer control line DT is equal to the high potential of the source line SL or the high potential of the gate line GL. The low potential of the data transfer control line DT is equal to the low potential of the binary data.

The entire write-in period includes a period t1 and a period t2 which successively follows the period t101.

During the period t1 of the entire write-in period T1, both potentials of the gate line GL and the data transfer control line DT is high, meanwhile, the potential of the refresh output control line RC becomes low. This turns on each of the transistors N1 and N2, so that the switching circuit SW1 enters the conductive state, and the data transfer section TS1 carries out the transfer operation. Then, first data (here, the first data is a high potential) supplied to the source line SL is written into the node PIX.

Next, during the time period t2, the potential of the gate line GL becomes low, meanwhile, the potential of the data transfer control line DT is kept high. In this case, the potential of the refresh output control line RC becomes low. This turns off the transistor N1, so that the switching circuit SW1 enters a non-conductive state. Further, since the transistor N2 keeps the ON state, the data transfer section TS1 keeps the transfer operation state. Accordingly, the first potential data is transferred from the node PIX to the node MRY, and the node PIX and the node MRY are non-conductive to the source line SL. This process corresponds to a state shown in (a) of FIG. 6.

Note that, during the entire write-in period T1, a start time tw of the period t1 is different between the rows. This is because a period in which data is written in one row cannot be overlapped with that in any other row while the switching circuits SW1 provided in the different rows are simultaneously turned on, as described above. However, during the entire write-in period T1, the period t1 in one row may be overlapped with that in any other row if a timing in which the period t1 is terminated is different between the rows. In other words, the period t2 is a period in which writing of data is carried out in another row.

Next, the refresh period T2 is simultaneously started at a time tr with respect to all the memory circuits MR1. During the refresh period T2, the source line SL has the high potential which is the first potential data.

The refresh period T2 includes periods t3 to t14.

During the period t3 of the refresh period T2, the potential of the gate line GL becomes low, and the potential of the data transfer control line DT becomes low, and in addition, the potential of the refresh output control line RC becomes low. This turns off the transistor N2, so that the data transfer section TS1 enters the non-transfer operation state. That is, the node PIX and the node MRY are non-conductive to each other. Each of the nodes PIX and MRY keeps holding the high potential. This process corresponds to a state shown in (b) of FIG. 6.

During the period t4, the potential of the gate line GL becomes high, and the potential of the data transfer control line DT is kept low, and in addition, the potential of the refresh output control line RC is kept low. This turns on the transistor N1, so that the switching circuit SW1 enters the conductive state. Accordingly, the high potential is written into the node PIX again from the source line SL.

During the period t5, the potential of the gate line GL becomes low, and the potential of the data transfer control line DT is kept low, and in addition, the potential of the refresh output control line RC is kept low. This turns off the transistor N1, so that the switching circuit SW1 enters the non-conductive state. That is, the node PIX is non-conductive to the source line SL, and keeps holding the high potential. The processes of the periods t4 and t5 correspond to a state shown in (c) of FIG. 6.

During the period t6, the potential of the gate line GL is kept low, and the potential of the data transfer control line DT is kept low, and in addition, the potential of the refresh output control line RC becomes high. This turns on the transistor N4, so that the refresh output control section RS1 carries out the first operation. Further, since the potential of the node MRY is high, the transistor N3 is in the ON state. Accordingly, the refresh output control section RS1 enters the active state, and the low potential is supplied from the data transfer control line DT to the node PIX via the transistors N3 and N4. That is, the data transfer control line DT also serves as a supply source VS1 of FIG. 5.

During the period t7, the potential of the gate line GL is kept low, and the potential of the data transfer control line DT is kept low, and in addition, the potential of the refresh output control line RC becomes low. This turns off the transistor N4, so that the refresh output control section RS1 carries out the second operation. Accordingly, the node PIX is non-conductive to the data transfer control line DT, and keeps the low potential. The processes of the periods t6 and t7 correspond to a state shown in (d) of FIG. 6.

During the period t8, the potential of the gate line GL is kept low, and the potential of the data transfer control line DT becomes high, and in addition, the potential of the refresh output control line RC is kept low. This turns on the transistor N2, so that the data transfer section TS1 enters the transfer operation state. Here, an electric charge is transferred between the capacitor Ca1 and the capacitor Cb1, so that both the potentials of the node PIX and the node MRY become low. A positive electric charge is transferred from the capacitor Cb1 to the capacitor Ca1 via the transistor N2 so that the potential of the node PIX is increased by a small voltage of ΔVx. However, the potential of the node PIX is still within a range of the low potential.

The period t8 is a period in which refreshed data is held in both the first data storage section DS1 and the second data storage section DS2 connected to each other via the data transfer section TS1. The period t8 can be set to be long.

During the period t9, the potential of the gate line GL is kept low, and the potential of the data transfer control line DT becomes low, and in addition, the potential of the refresh output control line RC is kept low. This turns off the transistor N2, so that the data transfer section TS1 enters the non-transfer operation state. That is, the node PIX and the node MRY are non-conductive to each other. Each of the nodes PIX and MRY keeps holding the low potential. The processes of the periods t8 and t9 correspond to a state shown in (e) of FIG. 6.

During the period t10, the potential of the gate line GL becomes high, and the potential of the data transfer control line DT is kept low, and in addition, the potential of the refresh output control line RC is kept low. This turns on the transistor N1, so that the switching circuit SW1 enters the conductive state. Accordingly, the high potential is written into the node PIX from the source line SL again.

During the period t11, the potential of the gate line GL becomes low, and the potential of the data transfer control line DT is kept low, and in addition, the potential of the refresh output control line RC is kept low. This turns off the transistor N1, so that the switching circuit SW1 enters the non-conductive state. That is, the node PIX is non-conductive to the source line SL, and keeps holding the high potential. The processes of the periods t10 and t11 correspond to a state shown in (f) of FIG. 6.

During the period t12, the potential of the gate line GL is kept low, and the potential of the data transfer control line DT is kept low, and in addition, the potential of the refresh output control line RC becomes high. This turns on the transistor N4, so that the refresh output control section RS1 carries out the first operation. Further, since the potential of the node MRY is low, the transistor N3 is in the OFF state, that is, the refresh output control section RS1 enters the inactive state, and stops supplying its output. Therefore the node PIX keeps holding the high potential.

During the period t13, the potential of the gate line GL is kept low, and the potential of the data transfer control line DT is kept low, and in addition, the potential of the refresh output control line RC becomes low. This turns off the transistor N4, so that the refresh output control section RS1 carries out the second operation. Accordingly, the node PIX keeps holding the high potential. The processes of the periods t12 and t13 correspond to a state shown in (g) of FIG. 6.

During the period t14, the potential of the gate line GL is kept low, and the potential of the data transfer control line DT becomes high, and in addition, the potential of the refresh output control line RC is kept low. This turns on the transistor N2, so that the data transfer section TS1 enters the transfer operation state. Here, an electric charge is transferred between the capacitor Ca1 and the capacitor Cb1, so that both the potentials of the node PIX and the node MRY become high. A positive electric charge is transferred from the capacitor Ca1 to the capacitor Cb1 via the transistor N2, so that the potential of the node PIX is reduced by a small voltage of ΔVy. However, the potential of the node PIX is still within a range of the high potential. This process corresponds to a state shown in (h) of FIG. 6.

The period t14 is a period in which refreshed data is held in both the first data storage section DS1 and the second data storage section DS2 connected to each other via the data transfer section TS1. The period t14 can be set to be long.

With the aforementioned operations, during the period t14, the data written during the period t1 of the entire write-in period T1 is restored at the node PIX and the node MRY. The potential of the node PIX is high during the periods t 1 to t5 and t10 to t14, and is low during the periods t6 to t9. Meanwhile, the potential of the node MRY is high during the periods t1 to t7 and t14, and is low during the periods t8 to t13.

In a case where the refresh period T2 is continued after the aforementioned operations, the drive signal generation circuit/video signal generation circuit 12 causes the memory circuit MR1 to repeat the operations of the periods t3 to t14. In a case where new data is written, the drive signal generation circuit/video signal generation circuit 12 controls the memory circuit MR1 to carry out a write-in operation, and terminates the refresh period T2.

According to the memory device 10, after the data is written into the first data storage section DS1 of the memory circuit MR1, the first potential data is supplied from the source line SL while the second potential data is supplied from the data transfer control line DT, as described above. This makes it possible to refresh the data written into the pixel memory 20 while reversing the potential of the data, without using the inverter.

Here, in a case where the polarity is not reversed in an AC manner, this will lead to image sticking or deterioration of the liquid crystal. Therefore, in a case where a voltage is applied to the liquid crystal, and even in a case where the voltage is not applied thereto, it is necessary to reverse the polarity the voltage applied to the liquid crystal without changing in an absolute value of the voltage. Therefore, as shown in FIG. 8, the potential of the common electrode COM is driven so as to be reversed between a high potential and a low potential every time a potential of the gate line GL becomes high and the transistor N1 is turned on. As described above, the common electrode COM is AC driven while the potential of the common electrode COM is reversed between the binary levels, whereby it is possible to display tones while the liquid crystal capacitor Clc is AC driven between a positive polarity and a negative polarity.

For example, in a case where a high potential and a low potential of a potential Vcom of the common electrode COM are equal to a high potential and a low potential of the binary data, respectively, combinations of data and Vcom can be such that (data, Vcom)=(H, H), (L, H), (H, L), (L, L). Therefore four tone patterns of negative black, negative white, positive white, and positive black can be displayed. As a result, the liquid crystal is driven so that a direction of the voltage applied to the liquid crystal is reversed every time the potential of the node PIX is refreshed, while the liquid crystal substantially keeps its display tone. Accordingly, the liquid crystal can be AC driven with positive and negative voltages whose effective values are constant.

Further, as shown in FIG. 8, level-shifting of the common electrode COM takes place only during a period in which the switching circuit SW1 is in a conductive state. Specifically, the binary level supplied to the common electrode COM is shifted only during a period in which the pixel electrode (node PIX) is connected to the source line SL via the switching circuit SW1. Accordingly, the level of the common electrode is shifted in a state in which the potential of the pixel electrode is fixed to be equal to the potential of the source line SL. Because of this, the potential held in the pixel electrode, in particular, the potential of the pixel electrode held during the refresh period can be prevented from being changed by the level shifting of the potential of the common electrode while the node PIX is in a floating state.

Note that (a) to (h) of FIG. 6 show transitions of the states of the pixel memory 20, and operation steps of the memory circuit MR1 of FIG. 8 can be divided as described below.

(1) Step A (Period t1 to Period t2 (Entire Write-in Period T1))

In the step A: the first potential data or the second potential data is written into the pixel memory 20 by making the switch circuit SW1 non-conductive in a state in which (i) the data is supplied to the source line SL from the drive signal generation circuit/video signal generation circuit 12 and the demultiplexer 13 and (ii) the second operation has been carried out by the refresh output control section RS1; and the transfer operation is carried out by the data transfer section TS1 in a state in which (i) the data is written into the pixel memory and (ii) the second operation has carried out by the refresh output control section RS1.

(2) Step B (Each of Periods t3 to t4 and Periods t9 to t10)

Following the step A, in the step B, data having a potential which is equal to a potential of the control information (which causes the refresh output control section RS1 to enter the active state) is inputted to the first data storage section DS1 via the source line SL by making the switch circuit SW1 non-conductive in a state in which (i) the second operation has been carried out by the refresh output control section RS1 and (ii) the non-transfer operation has been carried out by the data transfer section TS1.

(3) Step C (Each of Periods t5 to t6 and Periods t11 to t12)

Following the Step B, in the step C: the first operation is carried out by the refresh output control section RS1 in a state in which (i) the switch circuit SW1 is made non-conductive and (ii) the non-transfer operation has been carried out by the data transfer section TS1; and, at a time when the first operation is terminated, data having a reversal potential whose level is shifted from a potential of the control information (which causes the refresh output control section RS1 to enter the active state) is supplied to the input of the refresh output control section RS1 from the supply source VS1.

(4) Step D (Each of Periods t7 to t8, and Periods t13 to t14)

Following the step C, in the step D, the transfer operation is carried out by the data transfer section TS1 in a state in which (i) the switch circuit SW1 is made non-conductive and (ii) the second operation has been carried out by the refresh output control section RS1.

As a whole operation of the entire write-in operation, the step A is first carried out, and thereafter, following the step A, the series of operations (period t3 to period t8) from the start of the Step B to the end of the step D are carried out at least once.

Referring to FIG. 8, in the description of the data holding operation of the memory circuit MR1, a case where a high potential serving as the first potential data is written during the entire write-in period T1 has been described so far. However, in the same way as FIG. 8, a similar potential change is generated also in a case where a low potential serving as the second potential data is written during the entire write-in period T1.

Further, an order to carry out a whole operation during the refresh period T2 in the memory mode may be generated not by an external signal but by a clock generated by an oscillator or the like in the inside of the memory circuit. This eliminates the need to have an external system input a refresh order per predetermined time, and is advantageous in that a system can be configured flexibly.

As described above, in the memory mode, the drive signal generation circuit/video signal generation circuit 12 of the liquid crystal display device 10 can stop data and a circuit (such as an amplifier used for displaying multiple tones). This makes it possible to attains lower power consumption. Further, in the memory mode, the polarity of data can be refreshed in each pixel memory 20. Therefore, when the polarity is reversed in order to carry out the refresh operation, it is unnecessary to rewrite the data potential while charging and discharging the source line SL. This makes it possible to reduce power consumption. Furthermore, the polarity of the data can be reversed in the pixel memory 20. Therefore, when the polarity is reversed, it is unnecessary to rewrite the potential of the data while charging and discharging the source line SL. This makes it possible to reduce power consumption.

Further, the memory circuit MR1 as a memory circuit does not include an element causing remarkable increase in power consumption, such as a through current which is generated by the inverter for carrying out the refresh operation. This makes it possible to remarkably reduce power consumption in the memory mode, as compared with conventional products.

Here, in the memory mode, in a case where the liquid crystal display device 10 of the present example enters from the refresh period to the entire write-in period, the polarity of the potential of the common electrode COM is reversed between the refresh period and the entire write-in period. Then, screen noise is generated after the refresh period is switched to the entire write-in period.

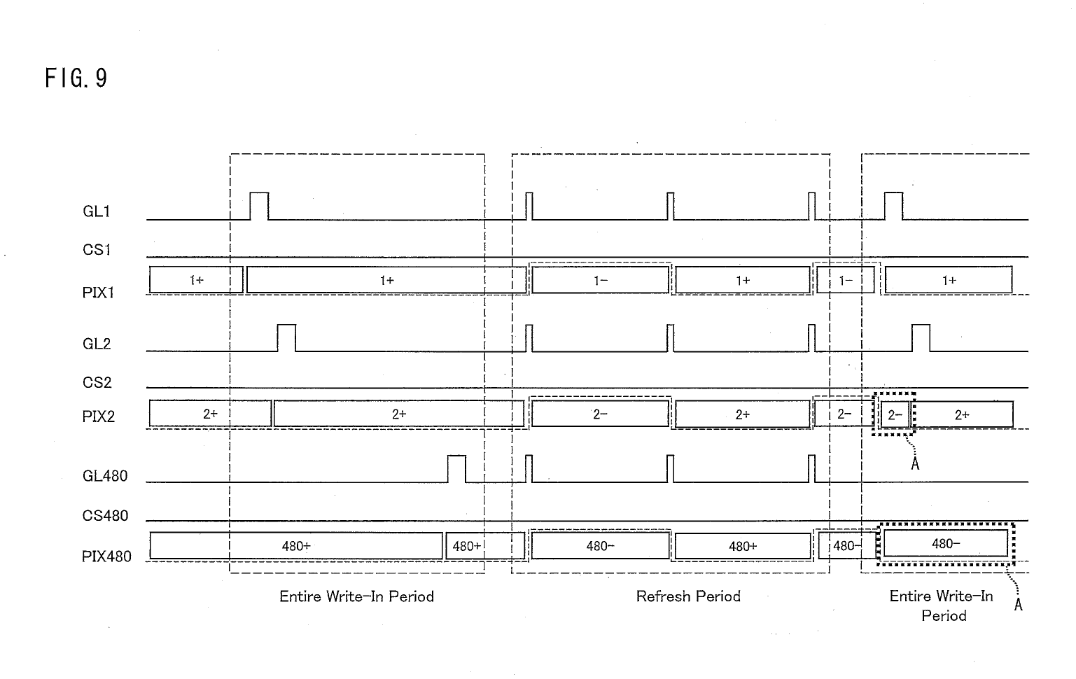

FIG. 9 is a timing chart showing various signal waveforms of the liquid crystal display device 10 in a case where screen noise is generated after the memory mode enters from the refresh period to the entire write-in period. The various signals of FIG. 9 are same as those of FIG. 3.

As shown in FIG. 9, after the refresh period is switched to the entire write-in period, i.e., during the entire write-in period, the gate lines GL are sequentially scanned. As a result, new data having a reversal potential is written into the first data storage section DS1 of the pixel memory 20, i.e., into the node PIX of the memory circuit MR1 line-sequentially.

Meanwhile, in a case where a liquid crystal capacitor is AC driven in the memory mode, the polarity of the common electrode COM is reversed in accordance with a timing in which a first gate line GL (i.e., a gate line GL1 in a 1st row in FIG. 9) of the entire write-in period is scanned. Consequently, in some memory circuit MR100, only the potential of the common electrode COM is reversed while new data having a reversal potential is not written to the node PIX. Accordingly, in such a memory circuit MR100, a voltage applied to the liquid crystal capacitor Clc is suddenly changed as shown by the dotted lines A of FIG. 9. In FIG. 9, the memory circuit MR1 in which such phenomenon described above is generated corresponds to each of the memory circuits driven by the 2nd gate line GL2 to the 480th gate line GL480. The node PIX of the memory circuit MR1 holds the data until new data having a reversal potential is written.

As a result, the screen noise (for example, a pixel which displays white during the refresh period is suddenly changed to black during the entire write-in period) is generated during a period in which only a polarity of the potential of the common electrode COM is reversed while a polarity of the potential of the node PIX in the memory circuit MR1 is not reversed, i.e., while the node PIX is in a floating state, as shown by the dotted lines A of FIG. 9.

Another point to note here is that, the liquid crystal display device 10 according to the present example carries out the following operations, so that screen noise, caused by the reversing of the potential of the common electrode COM, can be prevented from being generated after the memory mode enters from the refresh period to the entire write-in period.

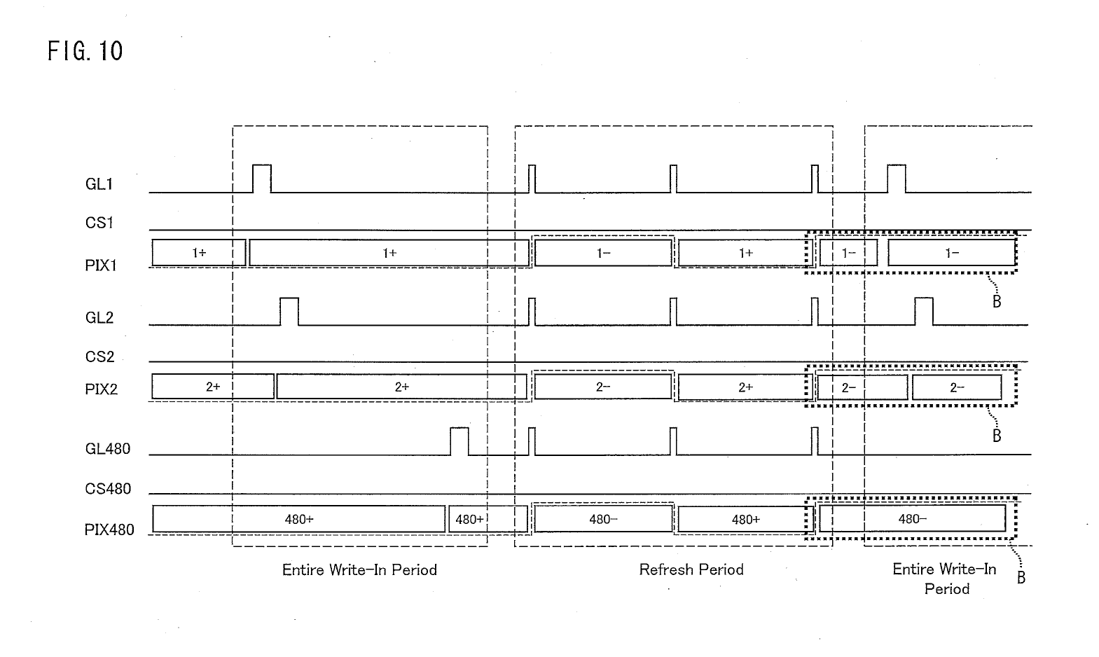

FIG. 10 is a timing chart showing various signal waveforms of the liquid crystal display device 10 in a case where an operation for preventing screen noise is carried out when the memory mode enters from the refresh period to the entire write-in period. The various signals of FIG. 10 are same as those of FIG. 3.

As shown by the dotted lines B of FIG. 10, in the memory mode, during the entire write-in period following the refresh period, the potential of the common electrode COM is set to be a potential which has been reversed in accordance with a timing in which the polarity of the potential of the pixel electrode is reversed at the end of the refresh period. That is, the polarity of the common electrode COM is not reversed during the entire write-in period following the refresh period, i.e., the common electrode COM holds the polarity, which has been changed at the end of the refresh period due to driving during the refresh period.

Accordingly, the polarity of the common electrode COM is not reversed during a period in which a node PIX of the memory circuit MR1 is in a floating state. This makes it possible to prevent screen noise.

Note that, as shown in FIGS. 3, 4, 9, and 10, the example where the pixel memories 20 of the liquid crystal display device 10 are scanned sequentially from the pixel memories 20 in the first row when the data is written has been described. However, the present invention is not limited thereto, and the order of the scanning can be changed in accordance with a design of the liquid crystal display device 10. Further, a driving method in the normal mode is preferably AC driving, however, various driving methods can be used.

Further, the memory circuit MR1 constituted by N-channel transistors has been described in FIG. 7. Alternatively, P-channel field effect transistors can be used. That is, the pixel memory 20 only needs to include an arrangement for carrying out the data holding operation which has been described with reference to FIGS. 5 and 6.

Further, in the aforementioned description, the memory circuit MR1 for carrying out the refresh operation accurately has been exemplified as the pixel memory 20. However, as a matter of course, the memory circuit MR100 may be used in view of prevention of screen noise. Still further, in view of the prevention of screen noise, the pixel memory 20 may be a memory circuit including a refresh control section for controlling a refresh operation and the like, and may operate (drive) to switch (i) a normal mode for stopping the refresh operation and (ii) a memory mode for carrying out the refresh operation. This memory circuit can have a similar effect to the present invention. In addition, the pixel memory 20 has two values (high potential and low potential) in the example, however, a ternary value or more may be used.

Further, the aforementioned liquid crystal display device 10 is applicable not only to a liquid crystal display device, but also to other display devices. For example, the present invention can be applied to a display device including a display element such as an dielectric liquid.

In order to attain the aforementioned object, a display device of the present invention includes: a display panel including memory circuits arranged in a matrix manner and a common electrode, the display device having a memory mode in which display is carried out with display data written and held in the memory circuits, the display data being held in the memory circuits by being refreshed, the memory mode including (i) an entire write-in period in which a potential of the common electrode is fixed and the display data is written into all the memory circuits in each row and (ii) a refresh period in which the display data which has been written during the entire write-in period is refreshed at least once while the common electrode is driven, in the memory mode, the potential of the common electrode during the entire write-in period being a potential which the common electrode having been driven had at the end of the refresh period preceding the entire write-in period.

Further, in order to attain the aforementioned object, a method for driving a display device of the present invention, which (i) includes a display panel including memory circuits arranged in a matrix manner and a common electrode and (ii) has a memory mode in which display is carried out with display data written and held in the memory circuits, the display data being held in the memory circuits by being refreshed, wherein: the method includes causing the memory mode to provide (i) an entire write-in period in which a potential of the common electrode is fixed and the display data is written into all the memory circuits in each row and (ii) a refresh period in which the display data which has been written during the entire write-in period is refreshed at least once while the common electrode is driven; and the method includes, in the memory mode, causing the common electrode to hold a potential during the entire write-in period following the refresh period, the potential having been changed by being driven at the end of the refresh period.

Screen noise would be generated conventionally in a case where a liquid crystal capacitor is AC driven in the memory mode. The reason is as follows: the polarity of the common electrode is reversed during the entire write-in period following the refresh period, specifically, at a timing in which data is written into a first row; and a voltage applied to the liquid crystal capacitor, which voltage corresponds to a voltage of a pixel electrode in a floating state, is suddenly changed.

In contrast, the aforementioned arrangement is formed such that, in the memory mode, the common electrode holds a potential during the entire write-in period following the refresh period, which potential has been changed by being driven at the end of the aforementioned refresh period. That is, the potential of the common electrode is not reversed. Accordingly, the polarity of the common electrode is not reversed while the pixel electrode is in a floating state, and this makes it possible to prevent screen noise.

Further, in the display device of the present invention, it is preferable that the display panel includes data signal lines, scanning signal lines, and storage capacitor lines; each of the memory circuits includes (i) a pixel electrode, (ii) a first switching circuit which switches over to electrically connect or electrically disconnect the pixel electrode and a corresponding one of the data signal lines with each other in response to a potential of a corresponding one of the scanning signal lines, (iii) a first capacitor provided between the pixel electrode and a corresponding one of the storage capacitor line, and (iv) a refresh control section for controlling to refresh the potential of the pixel electrode.

According to the aforementioned arrangement, in the memory circuit, the refresh control section controls to refresh the potential of the pixel electrode. This makes it possible to reduce power consumption of the refresh operation.

Still further, the display device of the present invention the display panel includes data transfer lines and refresh output lines; and the refresh control section includes (i) a memory electrode, (ii) a second switching circuit which switches over to electrically connect or electrically disconnect the pixel electrode and the memory electrode with each other in response to a potential of a corresponding one of the data transfer lines, (iii) a control section for supplying a potential to refresh the potential of the pixel electrode in accordance with potentials of the memory electrode and a corresponding one of the refresh output lines, and (iv) a second capacitor provided between the memory electrode and the corresponding one of the storage capacitor lines.

According to the aforementioned arrangement, in the memory circuit, the control section controls to refresh a potential of the pixel electrode. This eliminates the need to refresh from the outside of the memory circuit. This makes it possible to reduce power consumption of the refresh operation.

Yet further, the display device of the present invention each of the memory circuits further includes a potential supply source, the control section is a third switching circuit which switches over to electrically connect or electrically disconnect the potential supply source and the pixel electrode with each other in response to the potentials of the memory electrode and the corresponding one of the refresh output lines.

According to the aforementioned arrangement, the control section can be realized without including an inverter. This arrangement makes it possible to prevent increase in power consumption due to a through current. In addition, even if an off-leakage current exists in the transfer element used for the second switching circuit, a malfunction can be prevented by setting the pixel electrode and the memory electrode to have the same potential.

Further, the display device of the present invention, it is preferable that the first capacitor has a capacitance larger than that of the second capacitor;

the third switching circuit includes the third switching circuit includes (i) a first switch which switches over to electrically connect or electrically disconnect the potential supply source and the pixel electrode with each other in response to the potential held in the memory electrode and (ii) a second switch which switches over to electrically connect or electrically disconnect the potential supply source and the pixel electrode with each other in response to the potential of the corresponding one of the refresh output lines; and

the first switch and the second switch are provided between an input and an output of the third switching circuit so as to be connected to each other in series, the input being connected to the potential supply source, the output being connected to the pixel electrode.

According to the aforementioned arrangement, only the second switching circuit is made conductive, so that an electric charge is transferred between the first capacitor and the second capacitor. As a result, a potential of a memory electrode easily approximates to a potential of the pixel electrode, which potential is a potential before the second switching circuit is in a conductive state. This effect becomes more effective as a capacitance of the first capacitor becomes larger than a capacitance of the second capacitor. Further, the aforementioned arrangement can easily realize an arrangement in which, after the data signal potential is written into the pixel memory of the memory circuit, a potential for refreshing the pixel electrode is selectively supplied from the potential supply source, without using an inverter.

Further, in the display device of the present invention, it is preferable that the first switching circuit, the second switching circuit, the first switch, and the second switch are N-channel field effect transistors.

According to the aforementioned arrangement, the first switching circuit, the second switching circuit, the first switch, and the second switch are N-channel field effect transistors having the same polarity. This arrangement makes it possible to form the first switching circuit, the second switching circuit, the first switch, and the second switch at the same time, so that manufacturing processes of the display device are simplified. Further, all the switches and switching circuits are N-channel transistors, so that the memory circuit can be manufactured with use of amorphous silicon.

Further, in the display device of the present invention, it is preferable that the first switching circuit, the second switching circuit, the first switch, and the second switch are P-channel field effect transistors.

According to the aforementioned arrangement, the first switching circuit, the second switching circuit, the first switch, and the second switch are P-channel field effect transistors having the same polarity. This arrangement makes it possible to form the first switching circuit, the second switching circuit, the first switch, and the second switch at the same time, so that manufacturing processes of the display device are simplified.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably applicable to a display device which has a memory function and can display data held in carrying out a refresh operation. Further, the present invention is suitably applicable to a method for driving the display device and a method for manufacturing the display device. Furthermore, the present invention can be widely applicable to various electronic devices such as a display of a cell phone and the like.

### REFERENCE SIGNS LIST

10 liquid crystal display device (display device)
11 pixel array
12 drive signal generation circuit video signal generation circuit
13 demultiplexer
14 gate driver/CS driver
15 control signal buffer circuit
20 pixel memory
MR1, MR100 memory circuit
SW1, SW100 switching circuit (first switching circuit)
TS1, TS100 data transfer section (refresh output control section, second switching circuit)
RS1 refresh output control section (refresh control section, control section, third switching circuit)
RS100 refresh output control section (refresh control section, control section)
DS1, DS101 first data storage section
DS2, DS102 second data storage section
VS1 supply source (potential supply source)
Ca1, Ca100 capacitor (first capacitor)
Cb1, Cb100 capacitor (refresh output control section, second capacitor)
Clc liquid crystal capacitor
PIX node (pixel electrode)
MRY node (refresh output control section, memory electrode)
N1, N2 transistor
N3 transistor (first switch)
N4 transistor (second switch)
SL(j)(1≦j≦m), SLx source line (data signal line)
GL(i)(1≦i≦n), GLx gate line (scanning signal line)
DT(i)(1≦i≦n), DTx data transfer control line (data transfer line)
RC(i)(1≦i≦n), RCx refresh output control line (refresh output line)
CS(i)(1≦i≦n), CSx storage capacitor line

1. A display device, comprising:
a display panel including memory circuits arranged in a matrix manner and a common electrode,
the display device having a memory mode in which display is carried out with display data written and held in the memory circuits, the display data being held in the memory circuits by being refreshed,
the memory mode including (i) an entire write-in period in which a potential of the common electrode is fixed and the display data is written into all the memory circuits in each row and (ii) a refresh period in which the display data which has been written during the entire write-in period is refreshed at least once while the common electrode is driven,
in the memory mode, the potential of the common electrode during the entire write-in period being a potential which the common electrode having been driven had at the end of the refresh period preceding the entire write-in period.

2. The display device as set forth in claim 1, wherein:
the display panel includes data signal lines, scanning signal lines, and storage capacitor lines;
each of the memory circuits includes (i) a pixel electrode, (ii) a first switching circuit which switches over to electrically connect or electrically disconnect the pixel electrode and a corresponding one of the data signal lines with each other in response to a potential of a corresponding one of the scanning signal lines, (iii) a first capacitor provided between the pixel electrode and a corresponding one of the storage capacitor line, and (iv) a refresh control section for controlling to refresh the potential of the pixel electrode.

3. The display device as set forth in claim 2, wherein:
the display panel includes data transfer lines and refresh output lines; and
the refresh control section includes (i) a memory electrode, (ii) a second switching circuit which switches over to electrically connect or electrically disconnect the pixel electrode and the memory electrode with each other in response to a potential of a corresponding one of the data transfer lines, (iii) a control section for supplying a potential to refresh the potential of the pixel electrode in accordance with potentials of the memory electrode and a corresponding one of the refresh output lines, and (iv) a second capacitor provided between the memory electrode and the corresponding one of the storage capacitor lines.

4. The display device as set forth in claim 3, wherein:
each of the memory circuits further includes a potential supply source,
the control section is a third switching circuit which switches over to electrically connect or electrically disconnect the potential supply source and the pixel electrode with each other in response to the potentials of the memory electrode and the corresponding one of the refresh output lines.

5. The display device as set forth in claim 4, wherein:
the first capacitor has a capacitance larger than that of the second capacitor;
the third switching circuit includes (i) a first switch which switches over to electrically connect or electrically disconnect the potential supply source and the pixel electrode with each other in response to the potential held in the memory electrode and (ii) a second switch which switches over to electrically connect or electrically disconnect the potential supply source and the pixel electrode with each other in response to the potential of the corresponding one of the refresh output lines; and
the first switch and the second switch are provided between an input and an output of the third switching circuit so as to be connected to each other in series, the input being connected to the potential supply source, the output being connected to the pixel electrode.

6. The display device as set forth in claim 5, wherein
the first switching circuit, the second switching circuit, the first switch, and the second switch are N-channel field effect transistors.

7. The display device as set forth in claim 5,
the first switching circuit, the second switching circuit, the first switch, and the second switch are P-channel field effect transistors.

8. A method for driving a display device, which (i) includes a display panel including memory circuits arranged in a matrix manner and a common electrode and (ii) has a memory mode in which display is carried out with display data written and held in the memory circuits, the display data being held in the memory circuits by being refreshed, wherein:
the method comprises causing the memory mode to provide (i) an entire write-in period in which a potential of the common electrode is fixed and the display data is written into all the memory circuits in each row and (ii) a refresh period in which the display data which has been written during the entire write-in period is refreshed at least once while the common electrode is driven; and
the method comprises,
in the memory mode, causing the common electrode to hold a potential during the entire write-in period following the refresh period, the potential having been changed by being driven at the end of the refresh period.
